(19) United States
(12) Patent Application Publication
(10) Pub. No.: US 2025/0239417 A1
(43) Pub. Date: Jul. 24, 2025

(54) SYNERGETIC COMPOSITE PHASE-DEVELOPMENT OF SrO/CdO THIN FILM ELECTRODES VIA LAYER-BY-LAYER DEPOSITION FOR ENHANCED SUPERCAPACITOR PERFORMANCE

(71) Applicant: PRINCESS NOURAH BINT ABDULRAHMAN UNIVERSITY, Riyadh (SA)

(72) Inventors: Rushikesh G. BOBADE, Khopoli (IN); Thamraa ALSHAHRANI, Riyadh (SA); Bidhan PANDIT, London (GB); Revanappa C. AMBARE, Khopoli (IN); Anuj KUMAR, Mathura (IN); Abdullah M. AL-ENIZI, Riyadh (IN); Mohd UBAIDULLAH, Riyadh (SA); Mohd. SHKIR, Abha (SA); Yufeng ZHO, Shanghai (CN); Zonghua PU, Fuzhou (CN)

(73) Assignee: PRINCESS NOURAH BINT ABDULRAHMAN UNIVERSITY, Riyadh (SA)

(21) Appl. No.: 19/172,240

(22) Filed: Apr. 7, 2025

(51) Int. Cl. H01G 11/46; H01G 11/32; H01G 11/56

(52) U.S. Cl. CPC H01G 11/46; H01G 11/32; H01G 11/56

(57) ABSTRACT

The method for fabricating an asymmetric solid-state device (ASSD), comprising synthesizing an SrO//CdO composite thin film on a conductive substrate to form a positive electrode; providing an activated carbon negative electrode; preparing a gel electrolyte consisting of 1M Polyvinyl Alcohol-Potassium Hydroxide (PVA-KOH) composition for use between the positive and negative electrodes; stacking the SrO/CdO positive electrode, the 1M PVA-KOH gel electrolyte, and the AC negative electrode in a multi-layer arrangement; and pressing the stacked layers together to form the asymmetric solid-state device (ASSD). The asymmetric solid-state device, comprising a positive electrode comprising a SrO thin film and a CdO thin film on a conductive substrate; a negative electrode comprising activated carbon (AC); and a 1M PVA-KOH gel electrolyte positioned between the positive and negative electrodes, wherein the device is formed by stacking the components in layers and pressing them together.

### TECHNICAL FIELD

The present disclosure relates to the field of energy storage devices, specifically to the fabrication and development of thin-film electrodes for supercapacitors. More particularly, the invention pertains to a method for synthesizing Synergetic Composite Phase-Developed SrO/CdO Thin Film Electrodes using a layer-by-layer deposition technique to enhance electrochemical performance. The invention focuses on optimizing the structural, morphological, and electrochemical properties of SrO/CdO composite thin films to improve charge storage capacity, cycling stability, and overall supercapacitor efficiency.

### BACKGROUND

The rapidly evolving field of energy storage has seen growing interest in supercapacitors due to their high power density, long cycle life, and fast charge-discharge capabilities. As the demand for energy-efficient devices continues to rise across sectors such as electric vehicles, renewable energy storage systems, and consumer electronics, there is a crucial need for advanced electrode materials that can enhance both energy and power density in supercapacitors. Traditional supercapacitors, however, face limitations in energy storage capacity, prompting research into innovative materials and composite structures that can overcome these challenges.

In this context, strontium oxide (SrO) and cadmium oxide (CdO) have emerged as promising materials for supercapacitor electrodes. The high dielectric constant of SrO, when combined with the superior electrochemical properties of CdO, enables the formation of a synergetic composite phase that enhances supercapacitor performance. This composite material maximizes capacitance, cycling stability, and efficiency, making SrO/CdO thin-film electrodes highly desirable for real-world applications that demand both high power and energy densities.

The integration of SrO and CdO as thin films through a layer-by-layer deposition process is particularly advantageous for tailoring electrode surface morphology, thickness, and structural stability. The combination of SrO and CdO enhances the electrode's ability to store and release energy efficiently, primarily due to SrO's excellent ionic conductivity and CdO's stability in cyclic charge-discharge processes. This unique pairing provides the electrode with a high surface area and robust structural integrity, enabling it to withstand rigorous cycling conditions while minimizing energy loss. SrO supports ionic movement, while CdO ensures electrochemical stability, creating a composite phase that enables high energy storage and rapid power release—a crucial feature for applications requiring quick energy bursts, such as electric vehicles and grid storage systems.

To achieve the synergetic phase development of SrO/CdO thin-film electrodes, the present invention employs the Successive Ionic Layer Adsorption and Reaction (SILAR) method, an environmentally friendly and cost-effective thin-film deposition technique. SILAR enables precise control over film thickness and composition through alternating adsorption and reaction of ions, leading to uniform film growth with minimal material waste. This layer-by-layer deposition approach is particularly beneficial for fabricating SrO/CdO composites, as it allows sequential deposition of each component, ensuring optimal interaction at the molecular level. By utilizing the SILAR technique, the present invention achieves a high-performance, durable electrode with enhanced electrochemical properties, making it suitable for sustainable, high-capacity supercapacitors that contribute to advancements in energy storage technology.

Extensive research in the field of supercapacitors has focused on enhancing energy storage capacity, cycle stability, and power delivery by developing novel electrode materials. Traditional materials like activated carbon and metal oxides such as MnO₂ and NiO have been widely explored due to their ability to store and release energy effectively. However, these materials often struggle to achieve high energy density (SE) while maintaining durability over extended charge-discharge cycles. Recently, the focus has shifted to binary or composite metal oxides, such as SrO and CdO, which exhibit complementary electrochemical properties that enhance overall supercapacitor performance.

Despite SrO's high dielectric constant and CdO's excellent stability and conductivity, research on integrating these materials into a composite thin-film electrode remains limited. This presents a significant opportunity to develop high-performance electrodes using innovative fabrication techniques. The SILAR method, a well-established layer-by-layer deposition technique, has demonstrated effectiveness in fabricating thin films with controlled thickness and composition. Compared to complex and expensive methods like chemical vapor deposition (CVD) or sputtering, SILAR is simpler, cost-effective, and scalable, making it ideal for large-scale supercapacitor manufacturing.

Previous studies have shown that SILAR can enhance surface area and porosity—key factors for improving supercapacitor electrodes. However, limited research has explored the application of SILAR for SrO/CdO composites, particularly in the supercapacitor domain. This gap highlights an untapped opportunity to leverage SrO and CdO's synergistic properties through a precisely controlled layer-by-layer deposition strategy, addressing the need for high-energy density (SE) and high-power (SP) supercapacitors for modern energy storage applications.

In view of the foregoing discussion, it is portrayed that there is a need to have a method to synthesizing SrO/CdO composite thin-film electrodes using SILAR-based synergetic phase development, offering a scalable, cost-efficient, and high-performance solution for next-generation supercapacitor technology.

### BRIEF SUMMARY

The present disclosure seeks to provide a method to fabricating higher performance supercapacitor electrodes through a synergetic combination of strontium oxide (SrO) and cadmium oxide (CdO) thin films, developed via a layer-by-layer deposition technique. By leveraging the complementary electrochemical properties of SrO and CdO, this invention creates a composite phase that optimizes both energy density and power output, addressing the growing demand for efficient, long-lasting supercapacitors. The SILAR technique is employed to achieve precise, uniform deposition of SrO and CdO layers, allowing for tailored electrode architecture that enhances charge storage capacity, cycling stability, and ionic conductivity. This method enables cost-effective, scalable production of composite electrodes with high surface area, ideal porosity, and superior structural integrity, resulting in electrodes that can withstand extensive charge-discharge cycles with minimal performance degradation. The resultant SrO//CdO thin-film composite electrodes are particularly suited for applications requiring high energy and power densities, like electric vehicles, portable electronics device, as well renewable energy applications, providing a significant advancement in supercapacitor technology.

In an embodiment, an asymmetric solid-state device (ASSD) is disclosed. The device includes a positive electrode comprising a SrO thin film and a CdO thin film on a conductive substrate, wherein the SrO and CdO thin films are synthesized using a successive ionic layer adsorption and reaction (SILAR) method.

The device further includes a negative electrode comprising activated carbon (AC).

The device further includes a 1M PVA-KOH gel electrolyte positioned between the positive and negative electrodes, wherein the device is formed by stacking the components in layers and pressing them together.

In another embodiment, a method for fabricating an asymmetric solid-state device (ASSD) is disclosed. The method includes synthesizing an SrO//CdO composite thin film on a conductive substrate to form a positive electrode.

The method further includes providing an activated carbon (AC) negative electrode.

The method further includes preparing a gel electrolyte consisting of 1M Polyvinyl Alcohol-Potassium Hydroxide (PVA-KOH) composition for use between the positive and negative electrodes.

The method further includes stacking the SrO/CdO positive electrode, the 1M PVA-KOH gel electrolyte, and the AC negative electrode in a multi-layer arrangement.

The method further includes pressing the stacked layers together to form the asymmetric solid-state device (ASSD).

In one embodiment, the SrO and CdO thin films are synthesized using a solution-immersion layer-by-layer (SILAR) method, for uniform deposition and strong bonding to a conductive substrate, wherein the conductive substrate is stainless steel.

In a further embodiment, the SrO//CdO composite thin film, comprising preparing a first solution comprising 0.5 M Sr(NO₃)₂ in a first beaker, a second solution comprising distilled water in a second beaker, a third solution comprising 1 M NaOH in a third beaker, a fourth solution comprising distilled water in a fourth beaker, a fifth solution comprising 0.5 M Cd(NO₃)₂·₃H₂O in a fifth beaker, a sixth solution comprising distilled water in a sixth beaker, and a seventh solution comprising 1 M NaOH in a seventh beaker. Then, dipping a substrate into the first solution for 60 seconds and rinsing the substrate in the second solution for 20 seconds, wherein the dipping and rinsing of the substrate is repeated for 80 cycles for adsorption and reaction of the Sr(NO₃)₂ precursor. Then, dipping the substrate into the third solution to induce SrO precipitation and rinsing the substrate in the fourth solution. Then, dipping the substrate into the fifth solution for 60 seconds and rinsing the substrate in the sixth solution for 20 seconds for 80 cycles to ensure adsorption and reaction of the Cd(NO₃)₂ precursor. Then, dipping the substrate into the seventh solution to induce CdO precipitation and rinsing the substrate in the fourth solution. Thereafter, annealing the coated substrate at 623 K for 1 hour to enhance crystallinity and stability, thereby forming the SrO//CdO composite thin film.

In one of the above embodiments, the SrO thin film is synthesized by forming SrO from the reaction between Sr²⁺ ions from SrO(NO₃)₂ and hydroxide ions from NaOH solution.

Yet, in a further embodiment, the CdO thin film is synthesized by forming CdO from the reaction between cadmium hydroxide precipitated from Cd(NO₃)₂:₃H₂O and NaOH solution.

Yet, in another embodiment, the activated carbon (AC) negative electrode fabrication comprising preparing a polyvinyl alcohol (PVA) solution by dissolving 1 gram of polyvinyl alcohol (PVA) in 10-15 milliliters of distilled water. Then, heating and stirring the PVA solution until the PVA is completely dissolved. Then, adding activated carbon (AC) to the dissolved PVA solution and stirring the mixture. Then, drying the resulting PVA-AC slurry in a desiccator. Then, applying the dried PVA-AC slurry to a stainless steel (SS) substrate using a doctor blade to form a coated substrate. Then, air-drying the coated substrate at room temperature for approximately 4 hours. thereafter, heat-treating the air-dried coated substrate in a muffle furnace at approximately 353 K for approximately 6-7 hours.

In another embodiment, the PVA solution is heated and stirred at a temperature between approximately 343 K and approximately 353 K for approximately 2-3 hours.

In another embodiment, the AC is added to the dissolved PVA solution, and the mixture is stirred for approximately 2 hours at a temperature between approximately 343 K and approximately 353 K.

In another embodiment, the PVA-KOH gel electrolyte preparation, comprising the steps of dissolving 3-4 grams of polyvinyl alcohol (PVA) in 40-50 milliliters of double-distilled water (DDW) to obtain a mixture. Then, heating the mixture to a temperature of 348-353 K while continuously stirring to form a viscous, clear gel. Then, cooling the gel to room temperature. Then, gradually adding 10-15 milliliters of a 1 M KOH solution to the cooled gel and stirring the mixture for 6-7 hours. Then, transferring the resulting solution to a Petri dish. Thereafter, allowing the solution to dry at room temperature to form a flexible, uniform alkaline electrolyte separator layer.

An object of the present disclosure is to provide a method for synthesizing an SrO//CdO composite thin film electrode for supercapacitors using the SILAR technique, ensuring a layer-by-layer deposition process for enhanced energy storage.

Another object of the present disclosure is to develop a synergetic composite structure by depositing alternating layers of SrO and CdO, thereby improving the electrode's electrochemical stability and specific capacitance.

Another object of the present disclosure is to improve the crystallinity, adhesion, and electrochemical performance of the SrO//CdO thin film electrode through an annealing process post-deposition.

Another object of the present disclosure is to optimize the deposition cycle parameters, including immersion time, ion concentration, and rinsing steps, ensuring uniform growth and oxide formation for high-performance energy storage applications.

Another object of the present disclosure is to synthesize SrO and CdO layers using Sr(NO₃)₂ and Cd(NO₃)₂ solutions in combination with NaOH, ensuring stoichiometric control for improved dielectric and electrochemical properties.

Another object of the present disclosure is to achieve a controlled crystallite size in the range of 25-48 nm, ensuring enhanced energy density and electrochemical performance of the thin film electrode.

Another object of the present disclosure is to provide an SrO//CdO thin film electrode with a specific capacitance (Cs) exceeding 700 F/g at a sweep rate of 5 mV/s in a 1M KOH electrolyte, making it suitable for supercapacitor applications.

Yet another object of the present invention is to deliver an expeditious and cost-effective high-performance supercapacitor device using the SrO//CdO thin film electrode, ensuring rapid charge-discharge capabilities and minimal capacitance decay over 6000 cycles.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1(a) illustrates the X-ray diffraction (XRD) patterns of a synthesized SrO, CdO, and SrO//CdO thin film in accordance with an embodiment of the present disclosure;

FIG. 1(b) illustrates the FE-SEM image of SrO at 1 μm in accordance with an embodiment of the present disclosure;

FIG. 1(c) illustrates the FE-SEM image of CdO at 1 μm in accordance with an embodiment of the present disclosure;

FIG. 1(d) illustrates the FE-SEM image of the SrO//CdO thin film at 1 μm in accordance with an embodiment of the present disclosure;

FIG. 1(e) illustrates the TEM image of the SrO//CdO thin film at a magnification of 100 nm in accordance with an embodiment of the present disclosure;

FIG. 1(f) illustrates the wetability image of the SrO//CdO thin film in accordance with an embodiment of the present disclosure;

FIG. 2(a) illustrates the survey spectrum of SrO//CdO thin film, showing key peaks corresponding to Sr 3d, Cd 3d, O 1s, and C 1s in accordance with an embodiment of the present disclosure;

FIG. 2(b) illustrates the deconvoluted XPS spectrum of Sr 3d of SrO//CdO thin film in accordance with an embodiment of the present disclosure;

FIG. 2(c) illustrates the deconvoluted XPS spectrum of Cd 3d of SrO//CdO thin film in accordance with an embodiment of the present disclosure;

FIG. 2(d) illustrates the deconvoluted XPS spectrum of O 1s of SrO//CdO thin film in accordance with an embodiment of the present disclosure;

FIG. 2(e) illustrates the valence band spectra of SrO//CdO thin film in accordance with an embodiment of the present disclosure;

FIG. 3(a) illustrates the CV plots of a SrO, CdO, and SrO//CdO electrode at a sweep rate of 5 mV/s in accordance with an embodiment of the present disclosure;

FIG. 3(b) illustrates the plot of specific capacitance in F/g versus sweep rate in mV/s of SrO, CdO, and SrO//CdO electrode respectively in accordance with an embodiment of the present disclosure;

FIG. 3(c) illustrates the cyclic voltammetry plots of a SrO//CdO electrode at dissimilar sweep rates from 5-100 mV/s in accordance with an embodiment of the present disclosure;

FIG. 3(d) illustrates the plot of specific capacitance (Cs) in F/g versus dissimilar sweep rates from 5 to 100 mV/s respectively of the SrO//CdO electrode in accordance with an embodiment of the present disclosure;

FIG. 4(a) illustrates the GCD plots of the SrO//CdO electrode at current densities ranging from 4-9 A/g, illustrating the charge-discharge behavior in accordance with an embodiment of the present disclosure;

FIG. 4(b) illustrates the regon plot of SE in Wh/kg versus SP in W/kg of the SrO//CdO electrode in accordance with an embodiment of the present disclosure;

FIG. 4(c) illustrates the Nyquist plot of the SrO//CdO electrode, showing the internal resistance (Ri) of 0.9 Ω in accordance with an embodiment of the present disclosure;

FIG. 4(d) illustrates the equivalent circuit model used to fit an experimental EIS data in accordance with an embodiment of the present disclosure;

FIG. 4(e) illustrates the cycling durability plot, indicating 81.7% capacitance holding after 6000 cycles of the SrO//CdO electrode, demonstrating excellent long-term electrochemical stability in accordance with an embodiment of the present disclosure;

FIG. 5(a) illustrates the CV curves of the asymmetric device at varying sweep rates of 5-100 mV/s, showing a device electrochemical behavior at dissimilar sweep rates in accordance with an embodiment of the present disclosure;

FIG. 5(b) illustrates the plot of Cs in F/g versus sweep rate of SrO//CdO_{∥}1M PVA-KOH_{∥}AC ASSD device in accordance with an embodiment of the present disclosure;

FIG. 5(c) illustrates the GCD plots of the ASSD device at current densities ranging from 4-9 A/g, illustrating the charge-discharge behavior in accordance with an embodiment of the present disclosure;

FIG. 5(d) illustrates the regon plot of energy density in Wh/kg versus power density in W/kg of the ASSD device in accordance with an embodiment of the present disclosure;

FIG. 5(e) illustrates the cyclic stability test of the SrO//CdO_{∥}1M PVA-KOH_{∥}AC device, demonstrating excellent durability with 86.3% capacitance holding after 6000 cycles in accordance with an embodiment of the present disclosure;

FIG. 6 illustrates a block diagram of an asymmetric solid-state device (ASSD) in accordance with an embodiment of the present disclosure; and

FIG. 7 illustrates a flow chart of a method for fabricating an asymmetric solid-state device (ASSD) in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION:

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

### Materials

Strontium nitrate (Sr(NO₃)₂) (98% extra pure), cadmium nitrate (Cd(NO₃)₂·₃H₂O) (99% extra pure), Sodium hydroxide pallets (NaOH) (98% extra pure), potassium hydroxide (KOH), sulphuric acid (H₂SO₄), acetone, and polyvinyl alcohol (PVA). All chemicals were acquired from Merck Private Ltd and used without using extra purification. SS was used as a conducting substrate.

### Synthesis of SrO and CdO Thin Films

The SrO and CdO thin films are synthesized by a SILAR technique, involving a multi-step deposition process. For the SrO thin film, a 0.5 M SrO(NO₃)₂ solution is prepared in distilled water as the source of strontium ions. The substrate is sequentially dipped into this solution for 60 seconds to allow Sr²⁺ ions to adsorb onto the surface, followed by a 20-second rinse in distilled water to remove excess solution. Next, the substrate is dipped into a 1 M NaOH solution for 60 seconds, where hydroxide ions react with the strontium ions to form SrO on the substrate, followed by another 20-second rinse in distilled water. This cycle is repeated 80 times to ensure uniform film growth, after which the SrO thin film is annealed at 623 K for 1 hour to improve crystallinity and structural integrity. Similarly, for the CdO thin film, a 0.5 M Cd(NO₃)₂·₃H₂O solution is prepared as the cadmium ion source, with distilled water used for rinsing the substrate after each deposition cycle. A 1 M NaOH solution is used in the third beaker to precipitate cadmium hydroxide from the cadmium ions. The substrate is dipped alternately into the cadmium nitrate solution and the NaOH solution, with each dip lasting 60 seconds followed by a 20-second rinse in distilled water. This process is repeated for a total of 80 cycles to achieve uniform thin film deposition, and the films are annealed at 623 K for 1 hour to create a SrO thin film, enhance the crystallinity and electrochemical properties, making them suitable for supercapacitor electrode applications.

### Synthesis of SrO//CdO Composite Thin Films

The synthesis of the SrO//CdO composite thin film is carried out using a SILAR technique. For a deposition, the following solutions are prepared: 0.5 M Sr(NO₃)₂ in the first beaker, distilled water in the second beaker, 1 M NaOH in the third beaker, distilled water in the fourth beaker, 0.5 M Cd(NO₃)₂·₃H₂O in the fifth beaker, distilled water in the sixth beaker, and 1 M NaOH in the seventh beaker. The substrate is first dipped into the Sr(NO₃)₂ solution for 60 seconds, followed by rinsing in distilled water for 20 seconds. This process is repeated for 80 cycles to ensure thorough adsorption and reaction of the strontium precursor. The substrate is then dipped into the NaOH solution to precipitate SrO, followed by rinsing again in distilled water. The same process is applied for CdO by dipping the substrate into the Cd(NO₃)₂ solution and NaOH solution sequentially for 60 seconds each, with a 20-second rinse in distilled water between steps. After completing 80 cycles, the composite thin film is subjected to annealing at 623 K for 1 hour to improve the crystallinity and stability of the SrO//CdO composite, resulting in a high-performance electrode suitable for supercapacitor applications.

### Synthesis of PVA-KOH Solid State Electrolyte

To prepare a PVA-KOH solid-state electrolyte, a gel polymer separator is created by combining potassium hydroxide (KOH) and polyvinyl alcohol (PVA). First, 3-4 grams of PVA are dissolved in 40-50 milliliters of double-distilled water (DDW), and the mixture is heated to 348-353 K while being continuously stirred to form a viscous, clear gel. Once the solution cools to room temperature, 10-15 milliliters of a 1 M KOH solution are gradually added, and a mixture has stirred for 6-7 hours to ensure thorough blending. The resulting solution is a transparent, adhesive gel, which is carefully transferred to a Petri dish and allowed to dry at room temp. As it dries, a gel solidifies into a flexible, uniform alkaline electrolyte separator layer with excellent ionic conductivity and adhesion properties, making it suitable for use in a solid-state supercapacitor. This process produces a highly efficient gel electrolyte that functions effectively as both the electrolyte and separator in the final device.

### Synthesis of Activated Carbon (AC) Electrode

To fabricate an AC electrode, a polyvinyl alcohol (PVA) solution is prepared by dissolving 1 gram of PVA in 10-15 milliliters of distilled water. The mixture is continuously stirred and heated to a temp. of 343-353 K for 2-3 hours until a PVA is completely dissolved. Once dissolved, activated carbon (AC) is added to the solution, and the mixture is stirred for an additional 2 hours at a same temperature. This results in a uniform slurry of PVA-AC, which is placed in a desiccator to dry. The slurry is then carefully applied to a clean stainless steel (SS) substrate (approximately 15 cm by 20 cm) by a doctor blade, confirming the even, thin coating. A coated substrate is first air-dried at room temperature for about 4 hours and then subjected to heat treatment in a muffle furnace at 353 K for 6-7 hours to ensure proper adhesion and solidification of the AC layer. The final product is a durable, uniform AC electrode, ready for electrochemical testing and applications.

Fabrication of SrO//CdO_{∥}1M PVA-KOH_{∥}AC Asymmetric Devices

The fabrication of the SrO//CdO_{∥}1M PVA-KOH_{∥}AC asymmetric solid-state device (ASSD) followed a multi-layer assembly process. Initially, SrO and CdO thin films were synthesized as the positive electrode by a SILAR method, ensuring uniform deposition as well strong bonding to a conductive substrate. Simultaneously, AC was selected as the negative electrode because of its high surface area and reliable electrochemical performance. The device was constructed by stacking the SrO//CdO positive electrode, the PVA-KOH gel electrolyte, and the AC negative electrode in layers. This arrangement allowed for efficient ion conduction while electrically insulating the electrodes to prevent short-circuiting. The layers were carefully pressed together to ensure optimal contact between the electrodes and the electrolyte, improving both ionic and electronic conductivity. After assembly, the device was allowed to stabilize under standard conditions before undergoing electrochemical testing, confirming its structural stability and readiness for performance analysis.

### Physical Measurements

### Experiment Procedures for Supercapacitors Properties Measurements

The electrochemical properties of SrO//CdO thin film electrodes were assessed through CV, GCD, and EIS. This analysis employed a 3-electrode setup in a 1 M KOH electrolyte. Here, a flexible SrO//CdO nanocomposite thin films acted as a working electrode, with platinum electrode as well an Ag/AgCl electrode functioning as the counter as well reference electrodes, correspondingly. CV measurements were conducted at multiple scan rates within a potential range from −1.4 to 0.5 V. GCD evaluations were completed at various current densities, covering the same potential limits. For the EIS test, an AC signal of 10 mV was applied at a bias of 0.4 V, spanning a frequency from 100 Hz to 1 MHz.

$$C {s}_{( C V )} = \frac{1}{m v ( {v}_{f} - {v}_{i} )} {\int }_{{v}_{i}}^{{v}_{f}} I ( V ) dv \qquad ( 1 )$$

$$SE = \frac{0.5 \times {Cs}_{( G C D )} \times {( {v}_{f} - {v}_{i} )}^{2}}{3.6} \qquad ( 2 )$$

$$SP = \frac{3600 \times SE}{Δ t} \qquad ( 3 )$$

Where, “Cs_{(CV)}” specific capacitance in F/g using CV plots, “(V_{f}-Vᵢ)” potential window, ‘m’ active mass on electrode, ‘v’ sweep rate in mV/s, “∫ᵥ_{ᵢ}^{v}^{_{f}}” integral area under of CV curve, “SE” specific energy in Wh/kg, “SP” specific power in W/kg, “V” applied voltage in volt, “I (V)” current in mA.

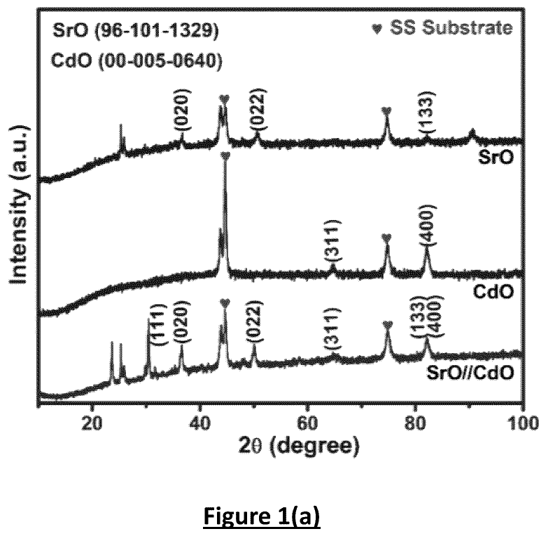

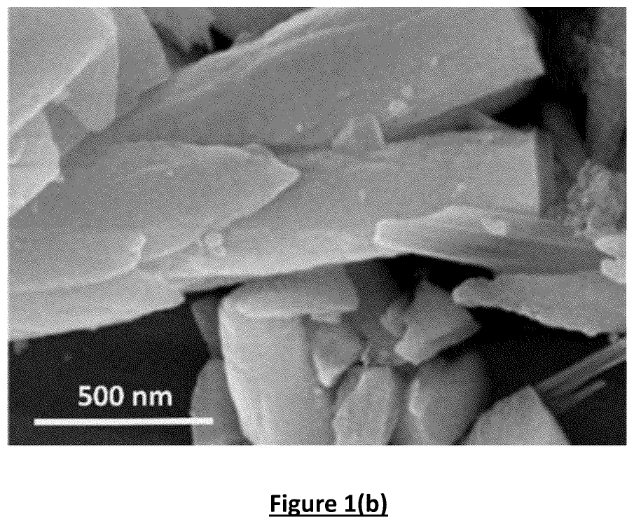

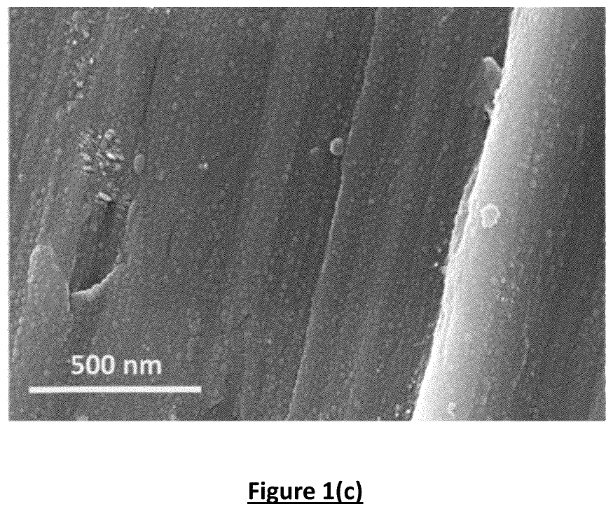

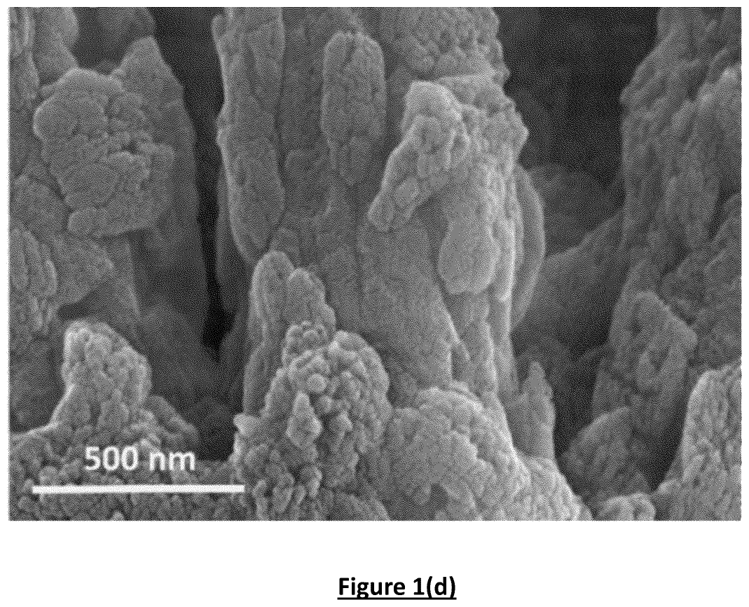

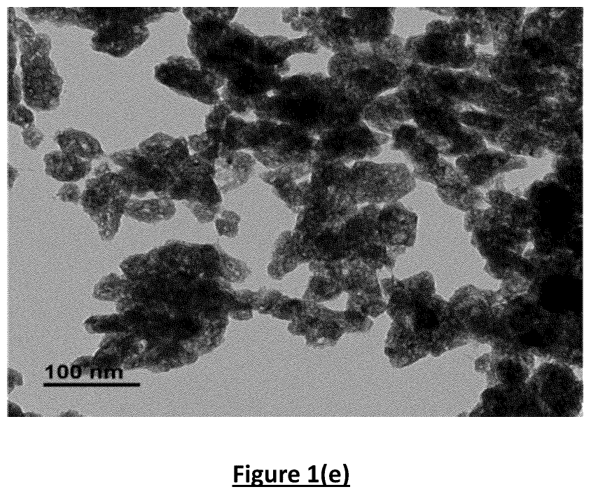

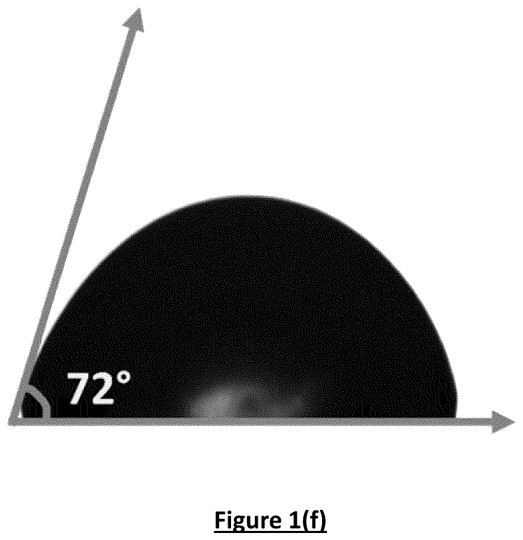

FIG. 1(a) illustrates the X-ray diffraction (XRD) patterns of a synthesized SrO, CdO, and SrO//CdO thin film in accordance with an embodiment of the present disclosure;

FIG. 1(b) illustrates the FE-SEM image of SrO at 1 μm in accordance with an embodiment of the present disclosure;

FIG. 1(c) illustrates the FE-SEM image of CdO at 1 μm in accordance with an embodiment of the present disclosure;

FIG. 1(d) illustrates the FE-SEM image of the SrO//CdO thin film at 1 μm in accordance with an embodiment of the present disclosure;

FIG. 1(e) illustrates the TEM image of the SrO//CdO thin film at a magnification of 100 nm in accordance with an embodiment of the present disclosure;

FIG. 1(f) illustrates the wetability image of the SrO//CdO thin film in accordance with an embodiment of the present disclosure;

FIG. 1(a-f): illustrates (a) X-ray diffraction (XRD) patterns of a synthesized SrO, CdO, and SrO//CdO thin film, The FE-SEM images at 1 μm of (b) SrO, (c) CdO, (d) SrO//CdO thin film, (e) TEM image of SrO//CdO thin film at magnification of 100 nm, (f) the wetability image of SrO//CdO thin film in accordance with an embodiment of the present disclosure.

FIG. 1(a) illustrates the X-ray diffraction (XRD) patterns of a synthesized SrO, CdO, and SrO//CdO thin film in accordance with an embodiment of the present disclosure.

FIG. 1(b) illustrates the FE-SEM image of SrO at 1 μm in accordance with an embodiment of the present disclosure.

FIG. 1(c) illustrates the FE-SEM image of CdO at 1 μm in accordance with an embodiment of the present disclosure.

FIG. 1(d) illustrates the FE-SEM image of the SrO//CdO thin film at 1 μm in accordance with an embodiment of the present disclosure.

FIG. 1(e) illustrates the TEM image of the SrO//CdO thin film at a magnification of 100 nm in accordance with an embodiment of the present disclosure.

FIG. 1(f) illustrates the wetability image of the SrO//CdO thin film in accordance with an embodiment of the present disclosure.

### XRD Analysis

The X-ray diffraction (XRD) analysis of a synthesized SrO, CdO, as well SrO//CdO thin films reveals distinctive peaks corresponding to their respective crystal structures, as shown in FIG. 1(a). For the SrO thin film, the observed diffraction peaks appear at 20 values of approximately 32.8°, 46.4°, and 55.2°, which correspond to the (020), (022), and (133) planes, respectively. These peaks match the standard SrO diffraction pattern (JCPDS No. 96-101-1329), confirming the successful synthesis of SrO with high crystallinity. The CdO thin film exhibits prominent peaks at 20 values of around 33.0°, 38.3°, 55.2°, and 65.9°, corresponding to the (111), (200), (220), and (311) planes, consistent with the CdO standard (JCPDS No. 00-005-0640). These well-defined peaks indicate the formation of a crystalline CdO thin film. In the SrO//CdO composite thin film, peaks from both SrO and CdO are visible, including prominent reflections at 32.9°, 46.5°, and 55.3°, representing SrO (020) and (133) planes, along with CdO (111) and (220) planes. This confirms the successful integration of SrO and CdO phases in the composite film without significant alteration to their individual crystal structures.

The crystallite sizes (D) of the SrO, CdO, and SrO//CdO thin films were calculated using Scherrer's formula. A calculated crystallite sizes for the SrO, CdO, as well SrO//CdO thin films are approximately 32 nm, 48 nm, and 25 nm, respectively. Notably, the SrO//CdO composite film has a reduced crystallite size compared to the individual SrO and CdO films. This reduction in crystallite size may result from strain at the SrO//CdO interface due to the layered deposition in the composite structure. The smaller crystallite size in the SrO//CdO composite could enhance its electrochemical performance by providing a larger active surface area and potentially improving ion diffusion.

### Morphological Analysis

The morphological analysis of the SrO, CdO, and SrO//CdO thin films, as illustrated in FIG. 1(b-d), provides insight into the surface structure and particle arrangement achieved through the SILAR method. In FIG. 1(b), the SrO thin film exhibits a relatively smooth surface with occasional granular formations, suggesting a uniform layer of SrO particles distributed across the thin film. A CdO thin film, as seen in FIG. 1(c), presents a more continuous and compact structure with fewer visible surface features. This morphology may contribute to the structural integrity and stability of the CdO layer. In the SrO//CdO composite film shown in FIG. 1(d), a notable difference is observed, the surface appears more porous with well-defined, rod-like structures. This unique morphology, likely resulting from the layered deposition process, can enhance the electrochemical properties by increasing the surface area and providing additional active sites for ion interaction, which has advantageous for supercapacitor applications.

The wettability of the SrO//CdO thin film was evaluated through contact angle measurement, as shown in FIG. 1(f), with a measured contact angle of 72°. This intermediate wettability suggests that the SrO//CdO surface possesses a balanced hydrophilic-hydrophobic nature, which is favorable for electrolyte absorption without compromising structural integrity. Such wettability is beneficial for supercapacitor electrodes, as it allows adequate electrolyte wetting, which is essential for efficient ion transfer throughout charging or discharging cycles. A combination of the porous morphology as well moderate wettability in the SrO//CdO thin film highlights its potential as an effective electrode, promoting both high surface area utilization and optimal electrolyte interaction.

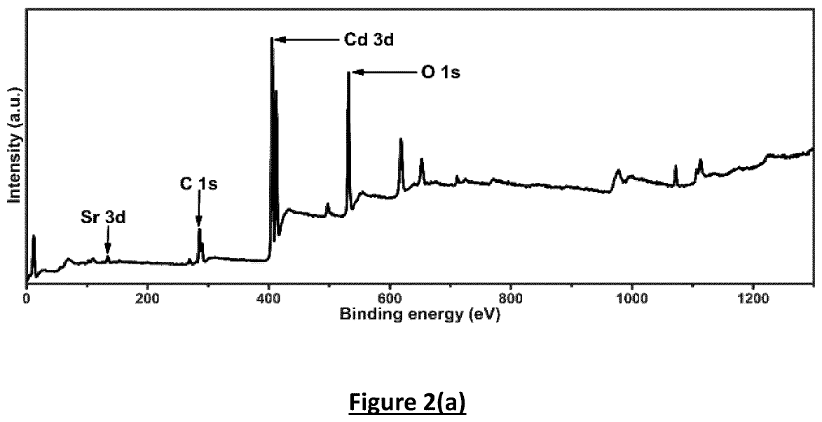

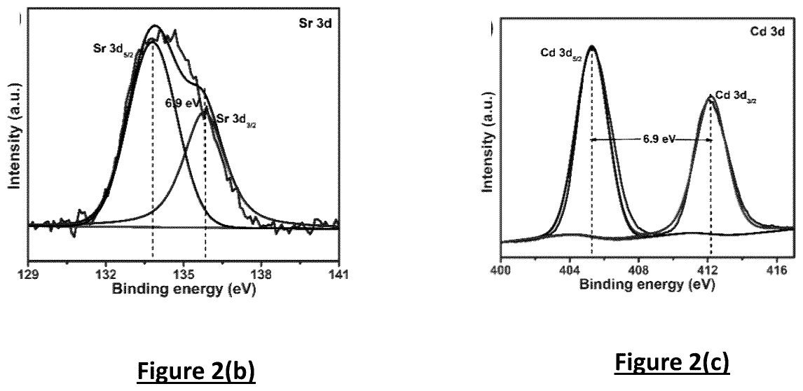

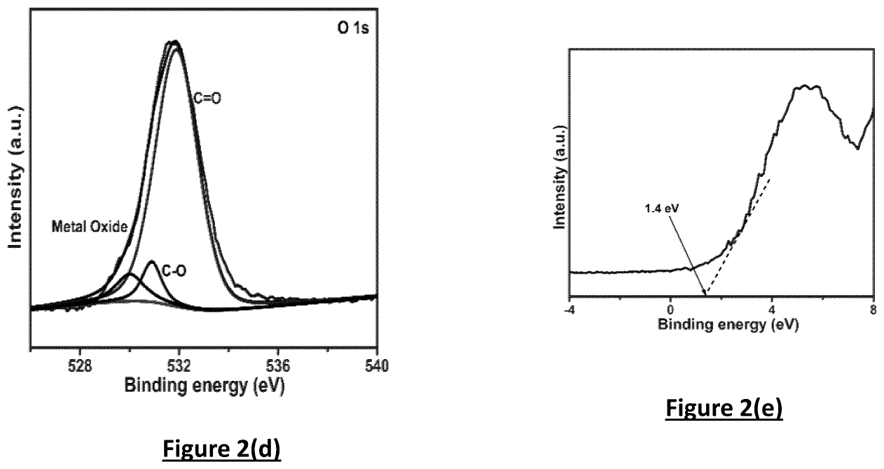

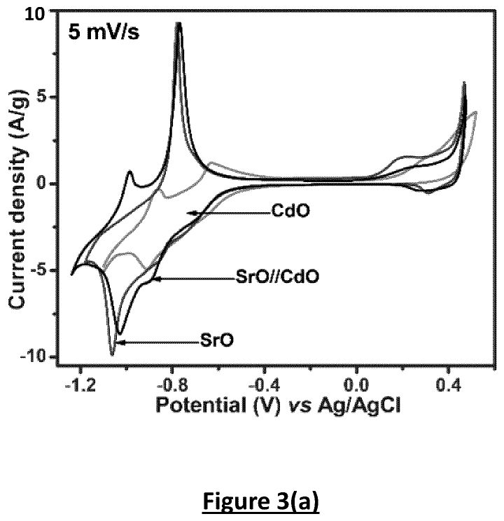

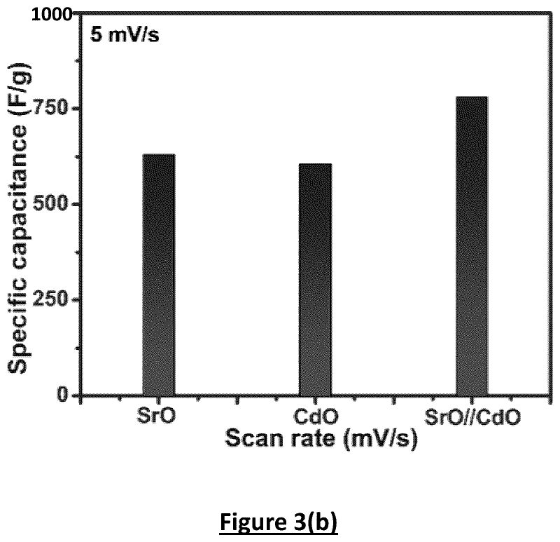

FIG. 2(a-e) illustrates (a) Survey spectrum of SrO//CdO thin film, showing key peaks corresponding to Sr 3d, Cd 3d, O 1s, and C 1s, deconvoluted XPS spectrum of (b) Sr 3d, (c) Cd 3d, (d) O 1s, (e) valance band spectra of SrO//CdO thin film in accordance with an embodiment of the present disclosure.

FIG. 2(a) illustrates the survey spectrum of SrO//CdO thin film, showing key peaks corresponding to Sr 3d, Cd 3d, O 1s, and C 1s in accordance with an embodiment of the present disclosure.

FIG. 2(b) illustrates the deconvoluted XPS spectrum of Sr 3d of SrO//CdO thin film in accordance with an embodiment of the present disclosure.

FIG. 2(c) illustrates the deconvoluted XPS spectrum of Cd 3d of SrO//CdO thin film in accordance with an embodiment of the present disclosure.

FIG. 2(d) illustrates the deconvoluted XPS spectrum of O 1s of SrO//CdO thin film in accordance with an embodiment of the present disclosure.

FIG. 2(e) illustrates the valence band spectra of SrO//CdO thin film in accordance with an embodiment of the present disclosure.

### XPS Analysis

The X-ray photoelectron spectroscopy (XPS) examination of a SrO//CdO thin film provides insights into the chemical composition as well oxidation states of Sr, Cd, and O in a synthesized thin film, as revealed in FIG. 2. A survey spectrum in FIG. 2(a) displays the characteristic peaks of Sr 3d, Cd 3d, O 1s, and C 1s, confirming a existence of strontium, cadmium, as well oxygen in a thin film. A peak corresponding to C 1s arises from adventitious carbon, often found on the surface of samples exposed to air. The high-resolution deconvoluted XPS spectra provide a detailed view of the oxidation states and electronic structure of Sr and Cd in the composite film.

The deconvoluted XPS spectra of Sr 3d, shown in FIG. 2(b), reveals 2 peaks located at binding energies of approximately 134.0 eV and 136.0 eV, corresponding to Sr 3d5/2 and Sr 3d3/2, correspondingly. The observed 3d peak positions and the energy separation of 6.9 eV between the doublets indicate that Sr is present in the +2 oxidation state, characteristic of SrO. This oxidation state aligns with the formation of strontium oxide (SrO), a desirable phase for supercapacitor applications due to its stability and ability to store charge. The XPS data confirm that Sr ions are fully oxidized, which could contribute positively to an electrochemical concert of a composite electrode through providing stable redox sites.

In FIG. 2(c), the deconvoluted spectrum for Cd 3d displays peaks at binding energies of 405.0 eV and 412.0 eV, conforming to Cd 3d5/2 and Cd 3d3/2, correspondingly. The energy separation of 6.9 eV between these two peaks further supports the +2 oxidation state of Cd, indicating the formation of cadmium oxide (CdO). The presence of CdO is essential for enhancing the capacitance and overall performance of the SrO//CdO composite film, as CdO provides active sites for charge storage as well contributes to the film stability. A distinct peaks of Cd 3d in the XPS spectrum demonstrate that cadmium is uniformly oxidized, suggesting that the SILAR deposition technique effectively produced a homogenous CdO layer within the composite film.

The O 1s spectrum, as depicted in FIG. 2(d), shows a peak centered around 530.5 eV, which is typically associated with metal oxide bonds (M—O). The deconvolution of this peak reveals contributions from both C—O and C═O bonds at slightly higher binding energies, which are likely due to surface-adsorbed species or minor contamination. The main O Is peak confirms the presence of oxygen in the form of metal oxides (SrO and CdO), essential for the film electrochemical functionality. The presence of oxygen in a well-bonded oxide form is crucial for ensuring the stability of the electrode material and its compatibility with electrolyte ions. The valence band spectrum shown in FIG. 2(e) shows a cutoff at approximately 1.4 eV, indicating a presence of a band gap in a SrO//CdO composite thin film.

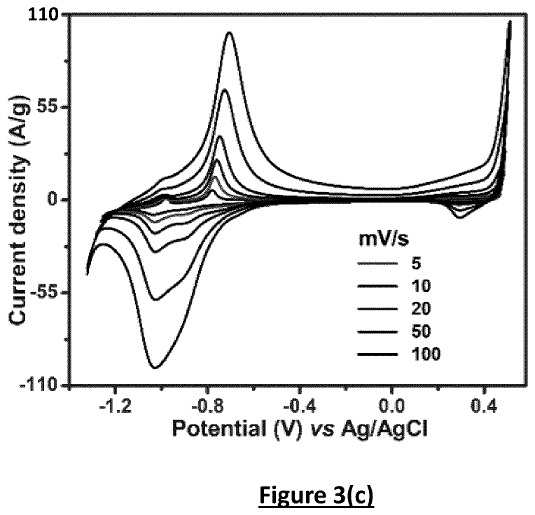

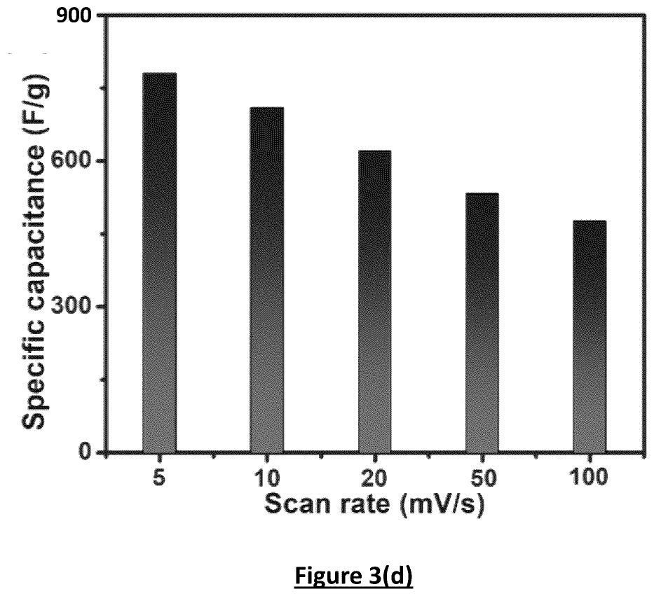

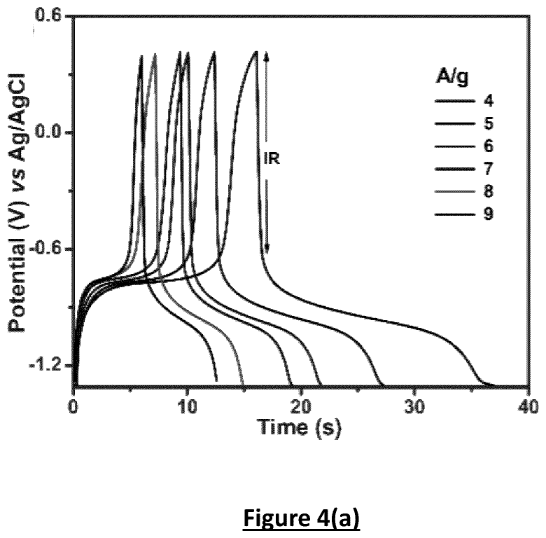

FIG. 3(a-d) illustrates (a) The CV plots of a SrO, CdO, and SrO//CdO electrode at sweep rate of 5 mV/s, (b) plot of specific capacitance in F/g versus sweep rate in mV/s of SrO, CdO, and SrO//CdO electrode respectively, (c) Cyclic voltammetry plots of a SrO//CdO electrode at dissimilar sweep rates from 5-100 mV/s, (d) plot of specific capacitance (Cs) in F/g versus dissimilar sweep rates from 5 to 100 mV/s respectively of SrO//CdO electrode in accordance with an embodiment of the present disclosure.

FIG. 3(a) illustrates the CV plots of a SrO, CdO, and SrO//CdO electrode at a sweep rate of 5 mV/s in accordance with an embodiment of the present disclosure.

FIG. 3(b) illustrates the plot of specific capacitance in F/g versus sweep rate in mV/s of SrO, CdO, and SrO//CdO electrode respectively in accordance with an embodiment of the present disclosure.

FIG. 3(c) illustrates the cyclic voltammetry plots of a SrO//CdO electrode at dissimilar sweep rates from 5-100 mV/s in accordance with an embodiment of the present disclosure.

FIG. 3(d) illustrates the plot of specific capacitance (Cs) in F/g versus dissimilar sweep rates from 5 to 100 mV/s respectively of the SrO//CdO electrode in accordance with an embodiment of the present disclosure.

### Electrochemical Studies

CV analysis of SrO//CdO Electrode

In FIG. 3(a), the CV plots of SrO, CdO, and SrO//CdO thin film electrodes at a sweep rate of 5 mV/s reveal significant differences in electrochemical behavior. The SrO as well CdO electrodes each exhibit characteristic redox peaks, suggesting pseudocapacitive charge storage. The SrO//CdO composite, however, demonstrates enhanced peak current densities in both oxidation and reduction regions, indicative of improved electrochemical activity. This can be ascribed to a synergistic effect among SrO as well CdO phases within a composite, which enhances an accessibility of active sites and improves the overall conductivity. The oxidation peaks around −0.6 V and the reduction peaks near −0.9 V vs Ag/AgCl reference electrode are particularly prominent in the SrO//CdO electrode, which can be associated with the reversible conversion of Sr and Cd between different oxidation states. The band gap of 1.4 eV suggests semiconducting behavior, which has beneficial for supercapacitor applications as it can facilitate charge transfer within the electrode. The semiconducting properties of the SrO//CdO composite film, coupled with the observed oxidation states of Sr and Cd, highlight a correctness of this material for energy applications. These faradaic reactions facilitate rapid electron transfer and contribute to the high specific capacitance Cs of the SrO//CdO electrode, recorded as 780 F/g at 5 mV/s, and SrO thin film shows the Cs of 630 F/g and CdO thin film shows the Cs of 605 F/g at 5 mV/s, respectively shows in FIG. 3(b). The integration of SrO and CdO appears to effectively utilize the redox capabilities of both materials, making the SrO//CdO electrode a more efficient energy storage material than either SrO or CdO alone.

In FIG. 3(c), the CV plots of a SrO//CdO electrode at varying sweep rates from 5-100 mV/s illustrate the electrode rate capability. At lower scan rates, the current response is sharp, and the redox peaks are well-defined, indicating efficient ion diffusion and utilization of an electrode active material. As the sweep rate increases, a peak currents rise proportionally, though with a slight broadening and shift, which is typical in pseudocapacitive materials as ion diffusion becomes rate-limiting. The redox reactions observed in the SrO//CdO composite are attributed to reversible faradaic processes involving Sr and Cd ions, interacting with K⁺ ions from the alkaline electrolyte. During the anodic sweep (oxidation), a prominent oxidation peak appears around −0.6 V vs Ag/AgCl, which resembles to the oxidation of Sr²⁺ and Cd²⁺ ions to higher oxidation states (Sr³⁺ and Cd³⁺), coupled with the incorporation of potassium ions (K⁺) from the electrolyte. This process facilitates electron release, contributing to an rise in current density. In a cathodic sweep (reduction), the reduction peak around −0.9 V signifies the reverse transition of Sr³⁺ and Cd³⁺ back to Sr²⁺ and Cd²⁺, accompanied by the release of K⁺ ions back into the electrolyte, completing the redox cycle. This reversible electrochemical reaction supports a stable charge-discharge process and contributes to high capacitance through the ongoing formation and breaking of chemical bonds, which is critical for the enhanced energy storage capability of the SrO//CdO electrode. The progressive shift and slight broadening of the peaks at higher scan rates indicate that, as the scan speed increases, ion diffusion becomes slightly limited, which reduces the full utilization of an active material. An electrode electrochemical mechanism, facilitated by K⁺ ions in the 1M KOH electrolyte, underscores the effective interaction among an electrode material as well electrolyte, resulting in efficient charge transfer and high-rate capability essential for supercapacitor applications.

The Cs values at different sweep rates, shown in FIG. 3(d), decrease with increasing scan rates 780 F/g at 5 mV/s to 476 F/g at 100 mV/s, which suggests that at higher scan rates, not all active sites within the electrode are accessed. This variation highlights a higher rate capability and stability of a SrO//CdO composite thin film for supercapacitor applications, where energy storage devices must balance capacity and charge-discharge rates. The overall performance underscores the potential of the SrO//CdO electrode manufactured by the SILAR technique as a auspicious candidate for high-performance, next-generation energy device.

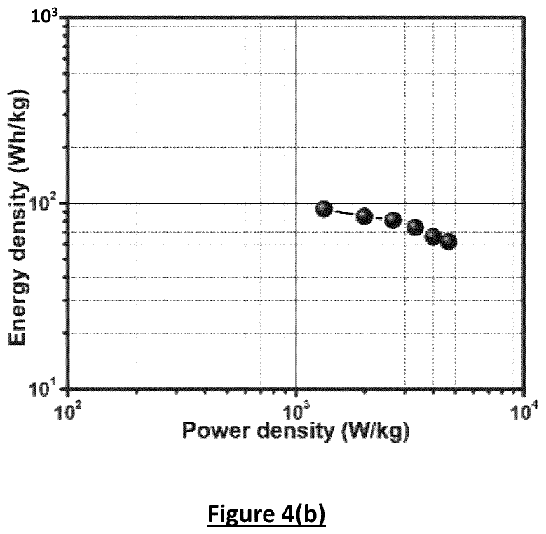

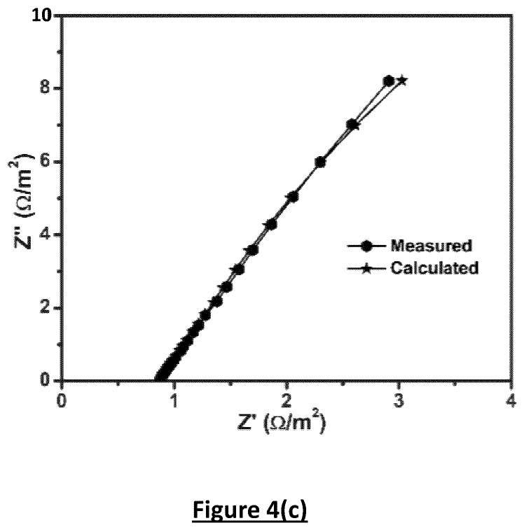

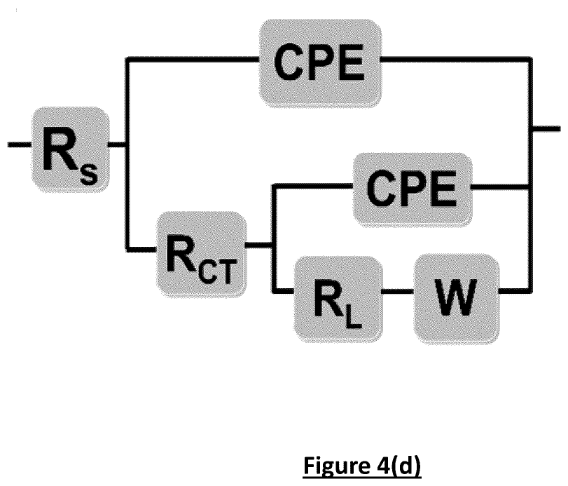

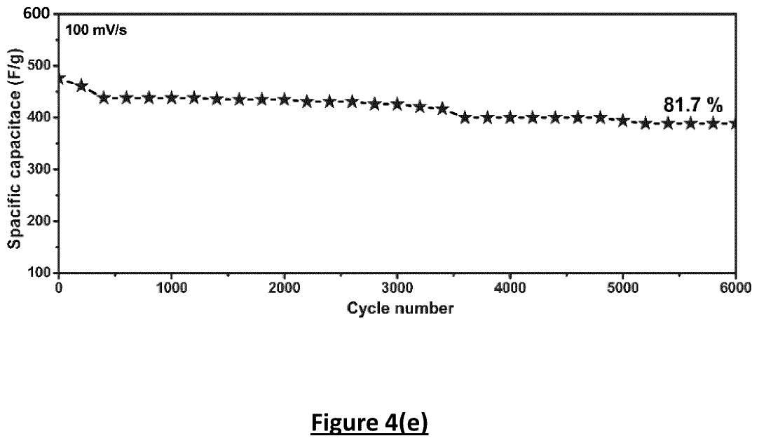

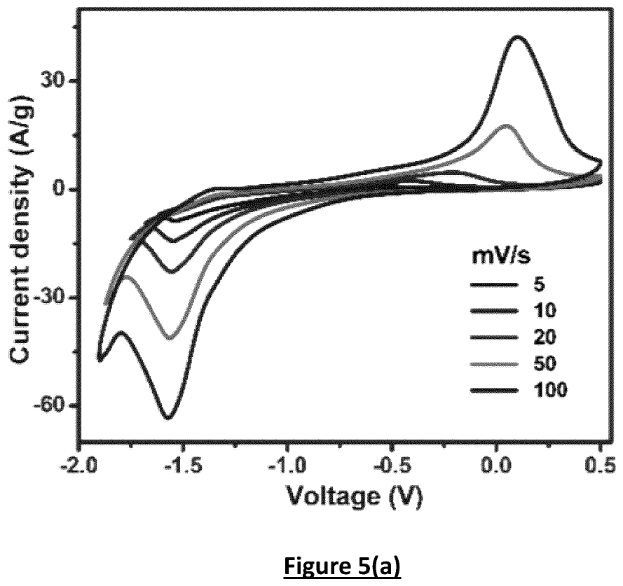

FIG. 4(a-e) illustrates (a) The GCD plots of the SrO//CdO electrode at current densities ranging from 4-9 A/g, illustrating the charge-discharge behavior, (b) regon plot of SE in Wh/kg versus SP in W/kg of SrO//CdO electrode, (c) Nyquist plot of the SrO//CdO electrode, showing the internal resistance (Ri) of 0.9 Ω, (d) the equivalent circuit model used to fit an experimental EIS data, (e) cycling durability plot, indicating 81.7% capacitance holding after 6000 cycles of SrO//CdO electrode, demonstrating excellent long-term electrochemical stability in accordance with an embodiment of the present disclosure.

FIG. 4(a) illustrates the GCD plots of the SrO//CdO electrode at current densities ranging from 4-9 A/g, illustrating the charge-discharge behavior in accordance with an embodiment of the present disclosure.

FIG. 4(b) illustrates the regon plot of SE in Wh/kg versus SP in W/kg of the SrO//CdO electrode in accordance with an embodiment of the present disclosure.

FIG. 4(c) illustrates the Nyquist plot of the SrO//CdO electrode, showing the internal resistance (Ri) of 0.9 Ω in accordance with an embodiment of the present disclosure;

FIG. 4(d) illustrates the equivalent circuit model used to fit an experimental EIS data in accordance with an embodiment of the present disclosure.

FIG. 4(e) illustrates the cycling durability plot, indicating 81.7% capacitance holding after 6000 cycles of the SrO//CdO electrode, demonstrating excellent long-term electrochemical stability in accordance with an embodiment of the present disclosure.

### GCD Analysis of SrO//CdO Electrode

The FIG. 4(a), the GC) plots of a SrO//CdO electrode, obtained at varying current densities of 4 to 9 A/g, demonstrate a clear dependence on the applied current density. As observed, a discharge time reduces with growing current density, which is characteristic of supercapacitive behavior. The IR drop, shown in each curve, becomes more pronounced at higher current densities, indicating internal resistance effects within the electrode. At lower current densities, such as 4 A/g, the electrode maintains a longer discharge duration, suggesting a higher Cs because of increased ion diffusion. As a current density rises, however, the charge-discharge curves show reduced discharge times, which is typical for high-rate supercapacitor devices as the accessible surface area decreases with faster ion transport requirements.

The FIG. 4(b), the Ragone plot, which maps the relationship among SE and SP, further elucidates a performance of the SrO//CdO electrode. At a lower current density of 4 A/g, the SE reaches a peak of 93 Wh/kg, with corresponding SP of 1330 W/kg. As the current density increases, trade-off between energy as well power density is evident, with an SE gradually decreasing to 62 Wh/kg at a maximum SP of 4670 W/kg at 9 A/g. This trend aligns with typical supercapacitor behavior, where energy density is sacrificed for power density at higher currents. The SrO//CdO electrode exhibits a well-balanced energy-power relationship, demonstrating its potential suitability for applications requiring both high power and moderate energy storage capabilities.

### EIS Analysis of SrO//CdO Electrode

The EIS analysis of a SrO//CdO thin film electrode synthesized by the SILAR method was conducted to assess its capacitive and resistive characteristics in supercapacitor applications. The FIG. 4(c) presents the Nyquist plot of the electrode, where the impedance data were collected under open-circuit potential (OCP) at −0.7449 V in a 1M KOH electrolyte, covering a broad frequency ranging from 1 mHz to 1 MHz. A plot demonstrates a semicircular feature in a high-to-medium frequency zone, accredited to charge transfer resistance (R_{CT}), surveyed by a nearly vertical line at a low-frequency end, which indicates ideal capacitive performance. The experimental data (solid green points) and the calculated data (pink stars) are in excellent agreement, as determined through the ZsimpWin fitting software. The small internal resistance (Ri) of 0.9 Ω and the series resistance (Rs) of 0.8924 Ω indicate low ionic and electronic resistance within the electrode-electrolyte interface, enhancing overall conductivity and charge mobility. The charge transfer resistance (R_{CT}) of 2.301 Ω demonstrates an effective electron transfer process at an electrode surface, while a presence of an inductive loop is explained by an in-series inductive clement (R_{L}=84.88 Ω), reflecting the bulk properties and electrode-electrolyte interfacial processes.

The FIG. 4(d) shows an equivalent circuit model used to simulate and interpret an experimental data, consisting of Rs, R_{CT}, and R_{L} along with constant phase elements (CPE) and a Warburg element (W) for representing diffusion-controlled processes. The values of the constant phase elements were found to be 9.346×10⁻⁵ F and 2.38×10⁻³ F, reflecting the non-ideal capacitive behavior due to the electrode porous structure and surface roughness. The Warburg clement (W) of 1.825 F indicates the significant diffusion of ions in an electrolyte towards an electrode surface, contributing to the high-energy storage capability of the SrO//CdO thin film. This comprehensive equivalent circuit model demonstrates excellent fitting to the EIS data and provides insight into the synergistic role of SrO and CdO phases in enhancing the electrochemical response. These findings underscore the effectiveness of the SILAR method for creating a highly conductive and capacitive electrode structure, paving the way for efficient supercapacitor devices.

### Stability Analysis of SrO//CdO Electrode

The long-term cycling stability of the SrO//CdO electrode, manufactured using the SILAR method for energy applications, was thoroughly evaluated through continuous CV testing, as illustrated in FIG. 4(e). An electrode underwent 6000 continuous cycles at a sweep rate of 100 mV/s in a 1M KOH electrolyte to ascertain its electrochemical durability and retention of specific capacitance. Initially, an electrode exhibited a higher Cs, underscoring its robust energy storage capability accredited to a synergistic contact among a SrO as well CdO phases. Throughout the cycling process, a gradual decrease in Cs has observed, primarily because of a slight degradation of the electrode's active material and mechanical stability over prolonged charge-discharge cycling. However, it is noteworthy that after 6000 cycles, the SrO//CdO thin film electrode retained an impressive 81.7% of its initial capacitance, indicating excellent cycling stability and demonstrating its potential for reliable and long-term energy storing applications.

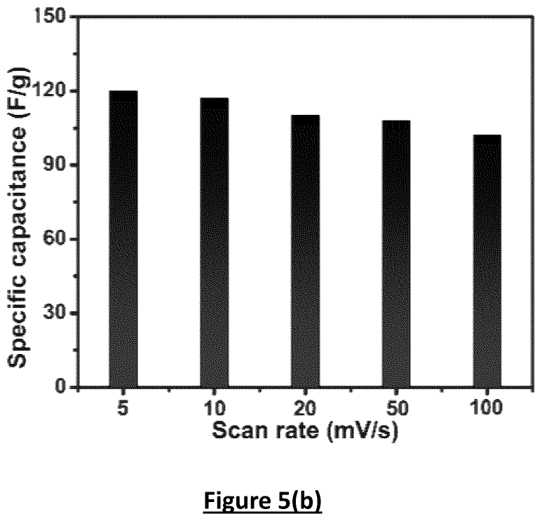

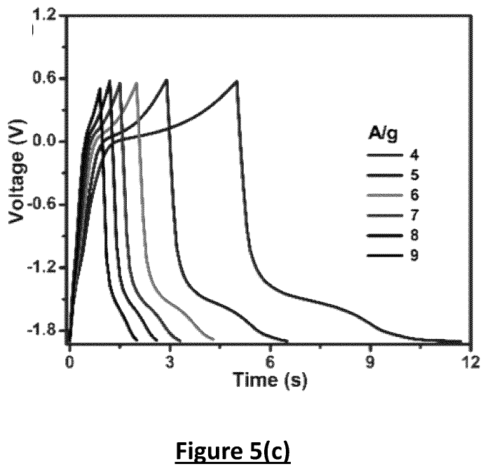

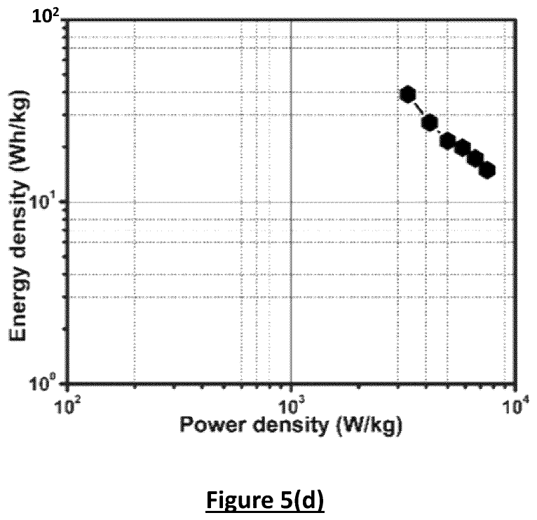

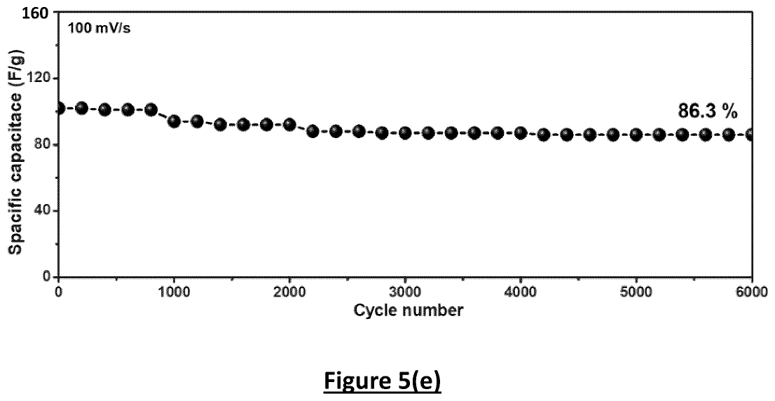

FIG. 5(a-c) illustrates (a) The CV curves of the asymmetric deice at varying sweep rates of 5-100 mV/s, showing a device electrochemical behavior at dissimilar sweep rates, (b) plot of Cs in F/g versus sweep rate of SrO//CdO_{∥}1M PVA-KOH_{∥}AC ASSD device, (c) The GCD plots of the ASSD device at current densities ranging of 4-9 A/g, illustrating the charge-discharge behavior, (d) regon plot of energy density in Wh/kg versus power density in W/kg of ASSD device, (e) cyclic stability test of the SrO//CdO_{∥}1M PVA-KOH_{∥}AC device, demonstrating excellent durability with 86.3% capacitance holding after 6000 cycles in accordance with an embodiment of the present disclosure.

FIG. 5(a) illustrates the CV curves of the asymmetric device at varying sweep rates of 5-100 mV/s, showing a device electrochemical behavior at dissimilar sweep rates in accordance with an embodiment of the present disclosure.

FIG. 5(b) illustrates the plot of Cs in F/g versus sweep rate of SrO//CdO_{∥}1M PVA-KOH_{∥}AC ASSD device in accordance with an embodiment of the present disclosure.

FIG. 5(c) illustrates the GCD plots of the ASSD device at current densities ranging from 4-9 A/g, illustrating the charge-discharge behavior in accordance with an embodiment of the present disclosure.

FIG. 5(d) illustrates the regon plot of energy density in Wh/kg versus power density in W/kg of the ASSD device in accordance with an embodiment of the present disclosure.

FIG. 5(e) illustrates the cyclic stability test of the SrO//CdO_{∥}1M PVA-KOH_{∥}AC device, demonstrating excellent durability with 86.3% capacitance holding after 6000 cycles in accordance with an embodiment of the present disclosure.

### Electrochemical Analysis of Asymmetric solid-State (ASSD) Device

### Cyclic Voltammetry (CV) Analysis of Device

The electrochemical concert of a SrO//CdO ASSD device was evaluated through CV analysis at various sweep rates ranging from 5-100 mV/s, as revealed in FIG. 5(a). A CV curves exhibit a nearly rectangular shape at lower scan rates, transitioning to a more distorted shape at higher scan rates, indicative of the pseudocapacitive performance contributed by the SrO and CdO phases. The broad peaks observed at intermediate potentials further confirm the presence of redox processes, characteristic of reversible faradaic reactions stirring at an electrode-electrolyte boundary. This redox behavior enhances the charge storage capacity, and the slight distortion of a CV plots at higher sweep rates suggests a rapid charging discharging response, further corroborating the excellent electrochemical kinetics of the SrO//CdO electrode. Importantly, the consistency of the current response across varying scan rates signifies excellent charge transfer dynamics and robust ionic diffusion paths within the electrode matrix. The wide potential window observed in the CV profiles extends the operational voltage range of the supercapacitor, thus boosting its overall energy storage capacity.

The Cs values of a ASSD as a function of sweep rate, illustrating the variation in capacitance retention with increasing sweep rates. At a sweep rate of 5 mV/s, a device achieves a maximum Cs of 120 F/g, which slightly decreases to 117, 110, 108, and 102 F/g at 10, 20, 50, and 100 mV/s, correspondingly as revealed in FIG. 5(b). This modest decline in capacitance with growing sweep rate is attributable to a reduced diffusion time available for electrolyte ions to penetrate deeper into an electrode pore at higher sweep rates. Nonetheless, the ASSD maintains a high capacitance retention even at elevated scan rates, demonstrating excellent rate capability and rapid charge-discharge characteristics. The high specific capacitance at lower scan rates emphasizes the efficient utilization of active sites within the SrO//CdO electrode, while the minimal decline at higher rates highlights the stable electrochemical performance and superior accessibility of ion channels. These results underscore the potential of the SrO//CdO ASSD for higher performance energy storing applications, combining higher Cs, excellent rate capability, as well reliable long-term cycling durability for next-generation supercapacitor devices.

### Galvanostatic Charge Discharge (GCD) Analysis of Device

The GCD plots of the asymmetric supercapacitor device (ASSD) are presented for current densities ranging of from 4-9 A/g exposed in FIG. 5(c). These GCD curves reveal the charge-discharge profiles, depicting the voltage variation over time during both charging as well discharging processes. At current density of 4 A/g, the device exhibits a more extended charge-discharge duration, demonstrating a relatively high capacitance performance. However, as the current density increases, the charge-discharge duration reduces significantly. This trend highlights the typical behavior of supercapacitors, where a higher current density leads to faster charge-discharge cycles due to increased ion movement within the electrode materials. Notably, the curves exhibit near-linear slopes during charging and discharging, indicating efficient and reversible energy storage and release with minimal internal resistance.

The FIG. 5(d) illustrates a Ragone plot, mapping the relationship between a energy density (Wh/kg) as well power density (W/kg) of an ASSD device across varying current densities. This plot provides insights into the energy-power trade-off of the device. At a lower current density of 4 A/g, the device achieves a peak SE of 39 Wh/kg, corresponding to a SP of 3320 W/kg. As a current density rises, an energy density gradually decreases, reaching 15 Wh/kg at a current density of 9 A/g, while a power density rises to 7490 W/kg. This behavior is indicative of the device capability to deliver higher power outputs at the expense of lower energy storage, a characteristic typical of high-performance supercapacitors. The consistent trend observed in the Ragone plot underscores the practical applicability of the SrO//CdO electrode manufactured via the SILAR method for high-power applications, where rapid charge-discharge cycles are critical. The data demonstrate that the ASSD device holds promising potential in applications demanding both high power and moderate energy storage capabilities.

### Stability Study of Device

The cyclic stability test of the asymmetric supercapacitor SrO//CdO_{∥}1M PVA-KOH_{∥}AC device, employing a 1M PVA-KOH gel electrolyte and activated carbon (AC) as the counter electrode as revealed in FIG. 5(e). A test was conducted at a constant current density over 6000 charge-discharge cycles, demonstrating the remarkable long-term permanency of a device. Initially, a Cs of a ASSD is maintained close to 120 F/g, with only a slight, gradual decrease observed over successive cycles. After 6000 cycles, the device retains 86.3% of its initial capacitance, indicating minimal degradation and robust performance under continuous operation. This high retention rate underscores the electrochemical stability of the SrO//CdO electrode material, which is likely attributable to the effective charge transfer kinetics and structural stability maintained throughout the cycling process. The minimal loss in capacitance demonstrates that the device can sustain repeated cycling with negligible adverse effects on its energy storing capabilities, production it a auspicious candidate for long-lasting energy applications.

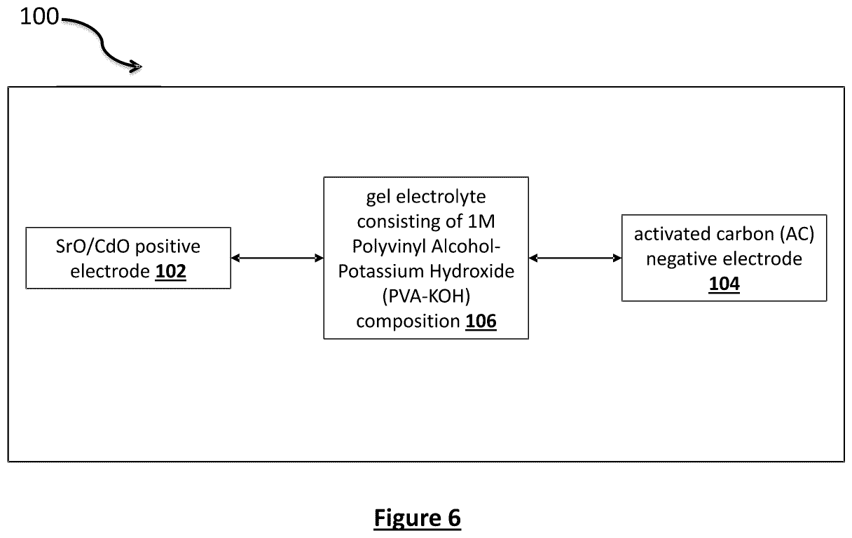

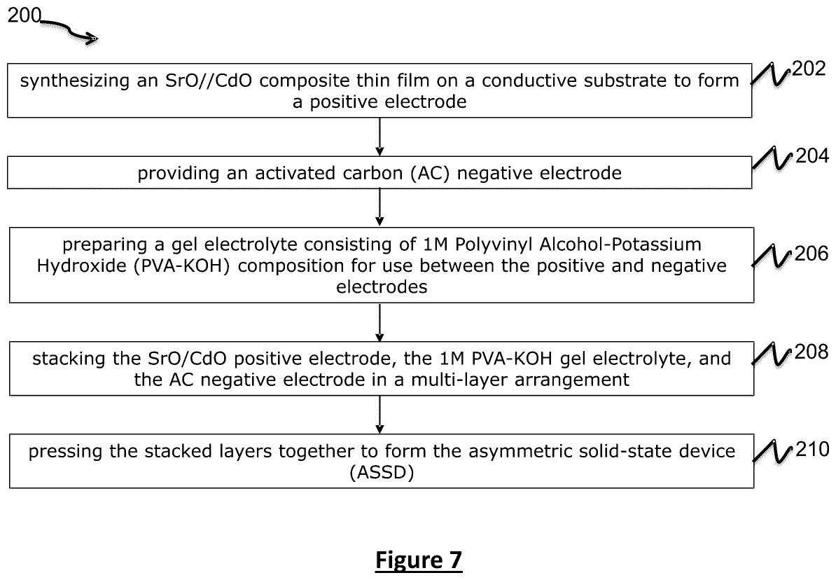

Referring to FIG. 6, a block diagram of an asymmetric solid-state device (ASSD) is illustrated in accordance with an embodiment of the present disclosure. The device (100) includes a positive electrode (102) comprising a SrO thin film and a CdO thin film on a conductive substrate, wherein the SrO and CdO thin films are synthesized using a successive ionic layer adsorption and reaction (SILAR) method.

In an embodiment, a negative electrode (104) comprising activated carbon (AC).

In an embodiment, a 1M PVA-KOH gel electrolyte (106) is positioned between the positive and negative electrodes, wherein the device is formed by stacking the components in layers and pressing them together.

FIG. 7 illustrates a flow chart of a method for fabricating an asymmetric solid-state device (ASSD) in accordance with an embodiment of the present disclosure. At step (202), method (200) includes synthesizing an SrO//CdO composite thin film on a conductive substrate to form a positive electrode.

At step (204), method (200) includes providing an activated carbon (AC) negative electrode.

At step (206), method (200) includes preparing a gel electrolyte consisting of 1M Polyvinyl Alcohol-Potassium Hydroxide (PVA-KOH) composition for use between the positive and negative electrodes.

At step (208), method (200) includes stacking the SrO/CdO positive electrode, the 1M PVA-KOH gel electrolyte, and the AC negative electrode in a multi-layer arrangement.

At step (210), method (200) includes pressing the stacked layers together to form the asymmetric solid-state device (ASSD).

In one embodiment, the SrO and CdO thin films are synthesized using a solution-immersion layer-by-layer (SILAR) method, for uniform deposition and strong bonding to a conductive substrate, wherein the conductive substrate is stainless steel.

In an embodiment, the step of synthesizing the SrO thin film using the SILAR method further comprises maintaining the pH of the NaOH solution used for SrO precipitation between approximately 12.5 and 13.2 to promote uniform nucleation and controlled grain growth of Sr(OH)₂ on the stainless-steel substrate, and wherein the temperature of the solution bath during the immersion cycles is maintained at 298-303 K to ensure controlled ionic interaction, and wherein the substrate is oriented vertically and agitated gently during each dipping step to avoid sedimentation and to ensure homogeneous film thickness, and wherein the rinsing duration after each Sr(NO₃)₂ immersion is precisely timed to avoid premature dissolution of loosely bound Sr²⁺ ions, and wherein the dipping cycles for CdO thin film deposition are carried out immediately after SrO deposition without any thermal treatment between the two processes, and wherein each Cd(NO₃)₂ dipping step is preceded by a 5-second exposure of the substrate to ultrasonic agitation to dislodge residual Sr(OH)₂ clusters, and wherein the NaOH solution for CdO precipitation is maintained at a temperature of 308-313 K to increase hydroxide ion mobility, and wherein each Cd(NO₃)₂ immersion is performed under low-light conditions to minimize unintended photolytic decomposition of the precursor, and wherein the rinsing steps use double-distilled water at a conductivity not exceeding 1 μS/cm to prevent ionic contamination.

In an exemplary embodiment of the disclosed method for fabricating a SrO//CdO-based thin-film supercapacitor, the process of synthesizing the SrO thin film via the Successive Ionic Layer Adsorption and Reaction (SILAR) technique is carried out with stringent control over multiple parameters to ensure the reproducibility, uniformity, and electrochemical efficacy of the resulting film. The process begins with the preparation of a sodium hydroxide (NaOH) bath maintained at a pH range of approximately 12.5 to 13.2. This specific alkalinity window is critical for enabling controlled and uniform nucleation of Sr(OH)₂ on the surface of the stainless-steel substrate, as it facilitates the slow and steady formation of Sr²⁺—OH⁻ complexes while preventing the formation of large, uncontrolled agglomerates. The temperature of the precursor solution during the immersion cycles is precisely maintained between 298 K and 303 K (approximately 25-30° C.), which serves to modulate ionic mobility and interaction kinetics, ensuring a gradual, layer-by-layer formation of the SrO precursor phase without inducing thermal gradients or rapid phase transitions that may compromise film continuity.

To achieve high film homogeneity and avoid sedimentation-related thickness variation, the stainless-steel substrate is mounted in a vertical orientation and subjected to gentle agitation—either through orbital motion or mechanical stirring of the solution bath—during each immersion step. This agitation ensures that the ionic concentration around the substrate remains uniform and that no stagnant zones develop, which could lead to uneven deposition. After immersion in the Sr(NO₃)₂ precursor solution, a precisely timed rinsing step is performed to eliminate unbound or loosely adhered Sr²⁺ ions without prematurely dissolving the growing Sr(OH)₂ layer. Typically, a rinse duration between 5 to 10 seconds with gentle agitation in double-distilled water is employed, and the water used has a conductivity not exceeding 1 μS/cm to avoid introducing ionic contaminants that could interfere with subsequent deposition steps.

Crucially, once the SrO deposition cycles are completed, the substrate is transitioned immediately to the CdO deposition stage without any intermediate thermal treatment. This continuity is vital to preserve the reactive hydroxylated surface morphology of the SrO film, which enhances subsequent anchoring of Cd²⁺ ions. Before each immersion in the Cd(NO₃)₂ precursor solution, the substrate is exposed to ultrasonic agitation for 5 seconds in deionized water to dislodge any residual Sr(OH)₂ clusters or loosely bound particles, thereby preparing a clean and reactive surface for Cd²⁺ adsorption. The NaOH solution used for CdO deposition is maintained at a slightly elevated temperature range of 308 K to 313 K to enhance the mobility of hydroxide ions, which is beneficial for rapid and complete precipitation of Cd(OH)₂ upon reaction with the adsorbed Cd²⁺ ions.

Furthermore, all Cd(NO₃)₂ immersion steps are carried out under low-light or subdued lighting conditions to minimize the risk of photolytic decomposition of the nitrate precursor, which can otherwise lead to the formation of non-stoichiometric by-products or oxynitrate species. After each dipping step, the rinsing is again performed using ultra-pure double-distilled water, and all rinse cycles are carefully optimized to balance removal of unreacted species with preservation of the chemically bonded thin film.

Collectively, this embodiment offers a high degree of control over microstructural properties such as grain size, film thickness uniformity, and interfacial bonding quality. By meticulously managing the precursor chemistries, solution pH, temperatures, agitation protocols, and contamination control measures, the resulting bilayer SrO//CdO film exhibits superior crystallinity, minimal interfacial voids, and enhanced electrochemical stability—thereby significantly contributing to the overall performance of the asymmetric solid-state supercapacitor device. For instance, electrochemical impedance spectroscopy (EIS) studies conducted on devices fabricated using this method reveal reduced charge transfer resistance (Rct) and enhanced ion diffusion pathways, supporting the technological efficacy of the proposed synthesis protocol.

In an embodiment, the annealing step of the SrO//CdO composite thin film is conducted in a programmable furnace under ambient atmospheric conditions with a controlled ramp-up rate of 5 K/min until the target temperature of 623 K is reached, wherein the film is held at 623 K for exactly 60 minutes followed by a controlled cooling rate of 2 K/min to room temperature to avoid thermal cracking, and wherein the annealing chamber is pre-heated and purged of moisture for 15 minutes prior to insertion of the coated substrate, and wherein the film is positioned at the geometric center of the furnace to maintain uniform heat distribution, and wherein the activated carbon (AC) used for the negative electrode is pre-treated by ultrasonication in ethanol for 30 minutes to remove organic impurities, followed by vacuum drying at 373 K for 4 hours before being added to the PVA solution, and wherein the PVA-AC slurry is continuously stirred using a magnetic stirrer operating at 400-500 rpm during the dissolution and mixing process to ensure uniform dispersion of AC particles, and wherein the dried PVA-AC film on the stainless-steel substrate is subjected to a surface profilometry test to confirm a coating thickness of 70-80 microns before being subjected to the heat-treatment step, and wherein the coated substrate is placed in the muffle furnace with its active surface facing upward on a ceramic tray to prevent distortion.

In an embodiment, the annealing step of the SrO//CdO composite thin film is executed with meticulous thermal and environmental control to enhance the crystallinity, interfacial adhesion, and phase purity of the bilayer structure, thereby significantly improving its electrochemical functionality in the final supercapacitor device. The coated stainless-steel substrate, bearing the as-deposited SrO and CdO layers via the SILAR method, is carefully positioned at the geometric center of a programmable furnace chamber. This central placement ensures uniform heat distribution across the substrate surface, which is essential to avoid localized thermal gradients that may cause non-uniform grain growth or film stress accumulation. Prior to loading the substrate, the furnace chamber is pre-heated to a sub-threshold temperature and purged of residual moisture for a duration of 15 minutes, typically using dry air or nitrogen gas, to establish a stable, ambient atmospheric environment free from humidity-induced defects or hydroxyl reformation.

The annealing process initiates with a controlled ramp-up rate of 5 K/min until the target annealing temperature of 623 K is attained. This gradual thermal increase is critical for preventing microcrack formation due to thermal shock and allows for the progressive relaxation of mechanical stress within the growing oxide matrix. Once the target temperature is reached, the substrate is held isothermally at 623 K for exactly 60 minutes. This thermal hold enables the coalescence and densification of nanocrystalline grains, promotes the transformation of Sr(OH)₂ and Cd(OH)₂ into their corresponding oxides, and facilitates interlayer diffusion to form a coherent heterojunction with minimal interfacial defects. Following the annealing hold, the cooling phase is equally controlled with a ramp-down rate of 2 K/min back to ambient temperature. Such slow cooling prevents thermal contraction mismatches between the film and substrate, effectively mitigating the risk of cracking or delamination.

Simultaneously, the preparation of the negative electrode based on activated carbon (AC) is executed with an emphasis on purity and uniformity. The AC material is initially subjected to ultrasonication in absolute ethanol for 30 minutes to dislodge and dissolve any adsorbed organic impurities or surfactants that may impede electrochemical performance. Post-cleaning, the AC is vacuum-dried at 373 K for four hours to remove residual moisture and solvent traces, thereby stabilizing the carbon surface for integration into the polymer matrix. The dried AC powder is then incorporated into a polyvinyl alcohol (PVA) solution to create a homogeneous PVA-AC slurry. This slurry is continuously stirred at a controlled rate of 400-500 rpm using a magnetic stirrer to ensure even dispersion of the carbon particles, which is crucial for obtaining a uniform, electrically conductive film upon deposition.

The resulting slurry is then cast onto a clean stainless-steel substrate and allowed to dry under ambient or mildly elevated temperature conditions. Once dried, the film undergoes surface profilometry using a non-contact optical method to confirm that the final coating thickness lies within the optimal range of 70-80 microns. Maintaining this thickness is vital for achieving sufficient surface area and electronic connectivity while avoiding excessive internal resistance. After thickness confirmation, the coated substrate is subjected to a post-deposition heat-treatment step within a muffle furnace. During this step, the sample is placed flat on a ceramic tray with its active layer facing upward to prevent physical deformation or warping of the film during heating. This final thermal treatment further removes any trapped solvents or binder residues, enhances film adhesion to the substrate, and promotes mechanical integrity.

In an embodiment, during the gel electrolyte preparation, the polyvinyl alcohol (PVA) is added gradually to pre-heated double-distilled water maintained at 348-353 K over a period of 15 minutes to avoid clumping, and wherein the stirring process is performed with a Teflon-coated overhead stirrer at 250-300 rpm to maintain homogeneity of the polymer solution, and wherein after cooling to ambient temperature, the 1 M KOH solution is introduced dropwise over 20 minutes under constant stirring to prevent localized pH spikes, and wherein the resulting gel is allowed to rest undisturbed for 2 hours to eliminate entrapped air bubbles before being cast into a Petri dish, and wherein the Petri dish is covered with a breathable film to control evaporation rate, resulting in a flexible, crack-free, and ionically conductive electrolyte layer with high mechanical integrity.

In an embodiment, the preparation of the gel electrolyte, which plays a central role in maintaining ionic conductivity and structural cohesion within the asymmetric solid-state supercapacitor device, is carried out with stringent process control to ensure consistency, mechanical robustness, and electrochemical performance. The process begins by gradually introducing polyvinyl alcohol (PVA) into pre-heated double-distilled water that is maintained in a temperature range of 348-353 K (75-80° C.). This temperature range is chosen specifically to accelerate the dissolution of the PVA granules while preserving the polymer's chain integrity. To prevent clumping and promote even solubilization, the PVA is added incrementally over a 15-minute period while the solution is stirred continuously using a Teflon-coated overhead stirrer operated at a speed of 250-300 rpm. The use of a Teflon coating minimizes shear degradation and prevents chemical interaction with the polymer solution, ensuring the long-term stability of the stirring apparatus and preserving the purity of the mixture.

As the polymer fully dissolves and the solution achieves homogeneity, it is allowed to cool gradually to ambient temperature to avoid thermal shock when the alkaline component is introduced. Once the temperature stabilizes, a 1 M potassium hydroxide (KOH) solution is added dropwise to the PVA solution over a span of 20 minutes. This controlled and gradual addition is critical for preventing localized pH spikes, which can otherwise lead to premature gelation, non-uniform ionic crosslinking, or even partial degradation of the polymer matrix. Continuous stirring is maintained throughout the KOH addition step to ensure that the alkaline ions are evenly dispersed throughout the polymer network, thereby promoting the uniform formation of the ionically conductive hydrogel.

Following the integration of KOH, the solution is allowed to rest undisturbed for two hours to enable the dissipation of any entrapped air bubbles formed during mixing. The elimination of air voids is crucial as such inclusions can act as mechanical stress concentrators or ionic discontinuities, ultimately affecting both the mechanical flexibility and electrochemical reliability of the final gel layer. Once bubble dissipation is complete, the gel is cast into a clean Petri dish using a uniform pouring technique. The dish is then covered with a breathable film, such as perforated parafilm or a hydrophilic membrane, to regulate the evaporation rate during gelation and solidification. This evaporation control ensures a gradual and uniform setting of the gel, which prevents the formation of cracks, phase separation, or surface skinning—common issues in uncontrolled drying conditions.

The result is a flexible, transparent, and crack-free PVA-KOH gel electrolyte layer with high ionic conductivity and excellent mechanical integrity, essential for maintaining intimate contact between the positive and negative electrodes during charge-discharge cycling. This method ensures that the gel maintains its dimensional stability, adheres uniformly to both electrode surfaces, and facilitates rapid ion transport across the electrochemical interface, thereby directly contributing to the enhanced performance and longevity of the assembled solid-state supercapacitor.

In an embodiment, the stacking of the SrO/CdO positive electrode, PVA-KOH gel electrolyte, and AC negative electrode is carried out in a controlled environment chamber with relative humidity maintained below 30% to prevent premature hydration or delamination of the gel layer, and wherein each layer is aligned using an optical micrometer system to ensure misalignment does not exceed ±10 microns, and wherein the pressure applied during the pressing step is calibrated at 5 MPa for a dwell time of 10 minutes using a hydraulic press with parallel platens, and wherein the pressing is conducted at a temperature of 313 K to soften the gel interface slightly, and wherein prior to initiating the SILAR deposition process, the stainless-steel conductive substrate is subjected to a dual-stage surface activation comprising: (i) chemical etching in a 1:1 volume ratio mixture of concentrated HCl and ethanol for 5 minutes to remove native oxide layers; and (ii) subsequent ultrasonication in acetone for 20 minutes followed by rinsing in distilled water and drying at 353 K, wherein the surface roughness is measured using atomic force microscopy (AFM) to confirm a Ra value of less than 50 nm before film deposition.

In an embodiment, the process of assembling the asymmetric solid-state supercapacitor—comprising the SrO/CdO composite thin-film positive electrode, the PVA-KOH gel electrolyte, and the activated carbon (AC)-based negative electrode—is executed under rigorously controlled environmental and mechanical conditions to ensure optimal device integrity, interfacial contact, and long-term electrochemical performance. The stacking of these layers takes place in a controlled environment chamber where the relative humidity is strictly maintained below 30%. This low-humidity condition is essential for preventing premature hydration of the gel electrolyte, which could otherwise result in interlayer delamination, compromised mechanical adhesion, and ionic conductivity inconsistencies during storage or operation.

To ensure mechanical precision and uniformity of layer alignment, each component—the positive electrode, gel electrolyte, and negative electrode—is aligned using an optical micrometer system capable of resolving positional discrepancies within ±10 microns. This high-precision alignment eliminates edge displacement or non-uniform pressure distribution across the stack, which can lead to device failure or increased series resistance. Once the layers are accurately aligned, the stack is subjected to a calibrated mechanical pressing process. A hydraulic press with parallel platens applies a uniform pressure of 5 MPa with a dwell time of 10 minutes. This pressure is chosen based on mechanical studies to provide sufficient interfacial bonding without damaging the delicate oxide or carbon-based layers.

The pressing operation is performed at a slightly elevated temperature of 313 K (approximately 40° C.), which serves a dual purpose: it softens the gel electrolyte to improve its conformity with the adjacent electrode surfaces and reduces the internal resistance of the assembled device by enhancing the ionic interface coupling. This temperature is carefully selected to be below the dehydration threshold of the hydrogel while remaining sufficient to promote subtle polymer chain mobility, allowing the gel to fill surface asperities and microvoids on both electrode surfaces.

Prior to initiating the SILAR-based deposition of the SrO and CdO films, the stainless-steel conductive substrate undergoes a meticulous dual-stage surface activation process to enhance film adhesion and uniformity. The first stage involves chemical etching using a 1:1 volume ratio solution of concentrated hydrochloric acid (HCl) and ethanol. This etching step is performed for 5 minutes to effectively remove native oxide layers, surface contaminants, and passivated regions from the metal substrate. Following the chemical treatment, the substrate undergoes a second stage of activation involving ultrasonication in acetone for 20 minutes. This step ensures the removal of any organic residues or by-products formed during the etching process. The substrate is then thoroughly rinsed in distilled water and dried at 353 K to eliminate residual solvent moisture and ensure surface stability.

To quantitatively verify surface readiness for thin-film growth, atomic force microscopy (AFM) is employed to measure the average surface roughness (Ra). Only substrates with a Ra value below 50 nm are deemed acceptable for deposition, as smoother surfaces promote uniform ionic layer adsorption and reduce the likelihood of film delamination or localized stress accumulation during thermal and mechanical cycles.

In an embodiment, after deposition of the SrO layer but before initiation of CdO layer deposition, the SrO-coated substrate is exposed to a mild oxygen plasma treatment for 3 minutes at a power of 100 W and a pressure of 0.2 Torr, wherein the plasma-treated surface undergoes temporary activation to increase the number of reactive surface hydroxyl groups, and wherein this surface activation step leads to enhanced anchoring of cadmium ions during the subsequent SILAR cycles, thereby reducing interfacial voids and improving heterojunction integrity between the SrO and CdO layers, and wherein the final SrO//CdO thin film prior to annealing is subjected to an in-situ UV-Vis absorbance scan in the range of 200-800 nm to confirm precursor film uniformity and light absorption consistency, and wherein only films that exhibit an absorbance variance of less than ±5% across scanned locations are subjected to thermal annealing.

In an embodiment, the fabrication process of the SrO//CdO composite thin film incorporates a strategically implemented oxygen plasma treatment step immediately following the completion of SrO layer deposition and prior to the commencement of CdO deposition via the SILAR method. This intermediate plasma treatment plays a critical role in modifying the surface chemistry and topography of the SrO layer to promote improved interfacial compatibility with the subsequently deposited CdO layer. The SrO-coated stainless-steel substrate is placed within a plasma chamber and subjected to an oxygen plasma environment operated at a power of 100 W and a chamber pressure of 0.2 Torr. The exposure duration is precisely timed for 3 minutes, which is sufficient to activate the film surface without inducing structural damage or over-etching.

During this process, reactive oxygen species generated in the low-pressure plasma atmosphere interact with the surface of the SrO layer, leading to the formation of transient reactive sites, predominantly hydroxyl (—OH) functional groups. These —OH groups increase the surface energy and hydrophilicity of the SrO film, thereby enhancing its chemical affinity for cadmium ions in the subsequent Cd(NO₃)₂ immersion steps of the SILAR cycle. As a result, this controlled surface activation leads to stronger electrostatic attraction and improved nucleation density of cadmium species, promoting uniform growth and anchoring of Cd(OH)₂. The outcome is a dense, conformal CdO layer with minimal interfacial voids and improved crystallographic compatibility at the SrO/CdO junction, which is crucial for heterojunction stability and charge transport efficiency in the final device.

Following the completion of the CdO deposition process, the entire SrO//CdO bilayer film is subjected to an in-situ ultraviolet-visible (UV-Vis) absorbance scan across the spectral range of 200 to 800 nm. This non-destructive characterization step serves to verify the optical and thickness uniformity of the deposited film. Uniform light absorbance across multiple scanned surface locations indicates consistent layer thickness and composition, which are essential for achieving predictable electrochemical behavior. Only those samples that demonstrate an absorbance variation of less than ±5% across the scanned regions are considered qualified for further thermal annealing. This threshold ensures that only films with minimal spatial variation and high deposition reproducibility proceed to the next stage of fabrication.

This embodiment underscores the critical role of interlayer engineering in thin-film fabrication, particularly for multi-material heterostructures intended for high-performance energy storage. The combination of mild plasma activation and real-time optical monitoring not only enhances heterojunction formation but also ensures process consistency and defect mitigation. Devices fabricated using this protocol exhibit lower equivalent series resistance (ESR) and improved charge transfer kinetics, as verified by electrochemical impedance spectroscopy and cyclic voltammetry tests. Thus, the described plasma-assisted interface modification step is not merely a surface treatment but an integral part of the overall process strategy to achieve robust, high-efficiency supercapacitor architectures.

In an embodiment, the NaOH solutions used for both SrO and CdO precipitation steps are pre-degassed using nitrogen bubbling for 15 minutes to eliminate dissolved oxygen, and wherein the solutions are filtered using 0.22 μm membrane filters immediately before use to eliminate particulate contaminants, and wherein the beakers containing these solutions are kept sealed with parafilm between dipping cycles, thereby ensuring minimal introduction of ambient CO₂ which could otherwise alter pH and introduce carbonate-related impurities into the oxide films, and wherein after formation of the SrO//CdO composite thin film but prior to device assembly, the film is aged under vacuum at a pressure of <0.01 Torr for 12 hours at room temperature to desorb any residual moisture and volatile contaminants from the surface, and wherein this vacuum-aging step is conducted in a glass desiccator with integrated humidity sensors to ensure internal RH does not exceed 5%.

In an embodiment, the synthesis of the SrO//CdO composite thin film incorporates a highly controlled chemical handling protocol designed to preserve the chemical integrity of the precursor solutions and the structural purity of the final deposited film. Specifically, during the preparation of the sodium hydroxide (NaOH) solutions used for both the SrO and CdO precipitation steps in the SILAR process, a pre-degassing treatment is applied. Nitrogen gas is bubbled through each NaOH solution for 15 minutes prior to use. This step serves to eliminate dissolved oxygen that could otherwise lead to unwanted oxidative reactions or shift the equilibrium of hydroxide ion concentration, thereby compromising the uniformity of nucleation and the stoichiometry of the resulting metal hydroxide intermediates.

Following the degassing, each solution is passed through a 0.22 μm membrane filter to remove any residual particulates or undissolved solids that could disrupt film smoothness or introduce nucleation anomalies. Maintaining a pristine chemical environment is critical at this stage because impurities or micro-particulates in the deposition bath may lead to localized overgrowth, grain boundary defects, or unintended secondary phase formation. After filtration, the solutions are transferred to chemically inert glass beakers which are tightly sealed with parafilm between each SILAR dipping cycle. This sealing practice prevents ambient carbon dioxide (CO₂) from diffusing into the highly alkaline solutions, which would otherwise result in the formation of carbonate species (e.g., SrCO₃ or CdCO₃) and thereby compromise the phase purity and electrical characteristics of the thin film. Such carbonate impurities are known to induce poor crystallinity, lower ionic conductivity, and increased charge transfer resistance in oxide-based supercapacitor electrodes.

Upon completion of the full SrO and CdO deposition cycles and prior to final device assembly, the composite thin film undergoes a critical vacuum aging process. This step involves placing the coated substrate in a high-integrity glass desiccator maintained at a vacuum pressure of less than 0.01 Torr. The vacuum aging is conducted at room temperature for a continuous period of 12 hours, during which any adsorbed moisture, residual nitrate ions, or volatile by-products from the SILAR process are desorbed from the film surface. The desiccator is equipped with integrated digital humidity sensors to ensure that the internal relative humidity (RH) remains below 5% throughout the aging process. Such a low-moisture environment is vital to stabilize the surface chemistry of the SrO//CdO bilayer and to prevent post-deposition hydrolysis or structural relaxation prior to thermal annealing or device stacking.

This embodiment ensures that the oxide layers are free from hydroxyl, carbonate, or moisture-related defects that could impair electrochemical performance or reduce device lifespan. For example, the vacuum-aged films demonstrate significantly improved cycling stability and lower initial leakage currents when subjected to galvanostatic charge-discharge testing. Furthermore, scanning electron microscopy (SEM) and X-ray photoelectron spectroscopy (XPS) analyses confirm the absence of carbonate species and verify the stoichiometric purity of the SrO and CdO phases. As a result, the combination of degassed, filtered, and sealed chemical preparation with post-deposition vacuum treatment provides a robust protocol for the fabrication of high-purity, defect-minimized thin films, forming the foundation for high-performance asymmetric solid-state supercapacitors.

In an embodiment, during the multi-layer stacking step, a thin interfacial buffer layer of 1-2 micrometers comprising a neutralized PVA-KOH dispersion is applied between each electrode and the gel electrolyte using spin-coating at 2000 rpm for 30 seconds, wherein the buffer layer serves to fill surface microvoids and enhance ionic contact, and wherein the thickness of each interface is verified via optical profilometry to maintain symmetric mechanical compression during pressing, thereby reducing internal resistance and improving ionic conductivity through the assembled ASSD, and wherein the assembled asymmetric solid-state device is subjected to a low-voltage electrochemical pre-conditioning step by applying a 0.5 V DC bias across the electrodes for 1 hour in a controlled chamber at 298 K and 20% RH.

In an embodiment, the performance and long-term stability of the asymmetric solid-state supercapacitor device (ASSD) are further enhanced through the strategic incorporation of a thin interfacial buffer layer during the multi-layer stacking step. This buffer layer, composed of a neutralized polyvinyl alcohol-potassium hydroxide (PVA-KOH) dispersion, plays a pivotal role in improving interfacial adhesion, ionic continuity, and mechanical compression symmetry between the functional layers—specifically, the SrO/CdO positive electrode, the central PVA-KOH gel electrolyte, and the activated carbon (AC) negative electrode. The dispersion is prepared to a carefully controlled viscosity and applied via spin-coating directly onto each electrode surface prior to final assembly.

The spin-coating process is carried out at a rotation speed of 2000 rpm for a duration of 30 seconds, resulting in a uniformly distributed film with a thickness of approximately 1 to 2 micrometers. This ultrathin buffer layer serves multiple critical functions: it fills the microscale surface voids and asperities inherent to both the electrode and gel surfaces, it enhances physical contact at the interfaces, and it reduces localized areas of poor ionic connectivity. These effects collectively reduce interfacial resistance and improve the effective ionic conductivity across the device structure.

To ensure precise control over the physical dimensions of the buffer layers, optical profilometry is employed to verify the thickness and uniformity of each interface. Symmetrical buffer layer thicknesses are essential to maintain balanced mechanical compression during the pressing step, which in turn ensures uniform stress distribution across the entire device. Without such balance, differential deformation could lead to delamination, non-uniform ionic migration paths, or early mechanical failure under cyclic operation. The buffer layer also acts as an ionic bridge that harmonizes the impedance profile between the oxide-based positive electrode and the porous carbon-based negative electrode, thereby smoothing potential gradients and enhancing charge-discharge homogeneity.

Once the buffer layers are confirmed and the multilayer assembly is complete, the fully stacked device is subjected to an electrochemical pre-conditioning step designed to stabilize the internal interfaces and initiate gentle ionic equilibration. A low-voltage DC bias of 0.5 V is applied across the two electrodes for a duration of 1 hour. This process is conducted in a controlled environmental chamber where the temperature is held constant at 298 K and the relative humidity is maintained at 20%, preventing moisture ingress or solvent swelling of the gel electrolyte during the biasing procedure. The pre-conditioning phase allows mobile ions to distribute uniformly throughout the electrolyte and electrode interfaces, fills remaining microscopic voids with hydrated ions, and enhances initial wettability across the active surfaces.

This embodiment ensures that the asymmetric supercapacitor device is not only mechanically robust but also electrochemically balanced and pre-activated for stable operation. Devices produced using this methodology consistently exhibit lower equivalent series resistance (ESR), improved initial capacitance, and reduced hysteresis in charge-discharge profiles during early-stage cycling. By addressing the critical interfacial dynamics through advanced surface engineering and controlled electrochemical activation, this process contributes directly to the enhancement of the device's long-term energy storage capabilities and reliability.

In an embodiment, after heat treatment of the activated carbon (AC) coated electrode, the surface is scanned using scanning electron microscopy (SEM) at 5 kV accelerating voltage to assess the particle distribution homogeneity, and wherein only electrodes exhibiting a pore distribution variance within ±10% are selected for device assembly, and wherein the selected electrode is then lightly polished with non-abrasive microfiber under nitrogen gas flow to remove loosely adhered particles, thereby ensuring consistent surface contact with the gel electrolyte and minimizing interface disruption under pressure, and wherein during the SrO deposition cycles, the dipping and rinsing sequence is interrupted every 20 cycles by a pause interval of 5 minutes to allow intermediate precursor settling, wherein during each pause, the substrate is suspended vertically in a nitrogen-purged chamber to prevent contamination, and wherein this staged deposition approach promotes layer densification and minimizes crack propagation by enabling periodic stabilization of ionic species on the surface.

In an embodiment, the fabrication process for the negative electrode of the asymmetric solid-state supercapacitor (ASSD), which utilizes activated carbon (AC) coated onto a stainless-steel substrate, is further refined through a series of post-treatment quality assurance and surface preparation steps designed to optimize interfacial uniformity and electrochemical reliability. Following the heat treatment of the AC-coated substrate—typically conducted to remove residual solvents and enhance the mechanical integrity of the AC matrix—the electrode surface is subjected to high-resolution scanning electron microscopy (SEM) analysis at an accelerating voltage of 5 kV. This imaging step is crucial for assessing the spatial distribution of carbon particles, ensuring uniform porosity, and verifying the absence of particle clustering or microstructural anomalies. Only those electrodes exhibiting a pore distribution variance of less than ±10%—as determined by image analysis software—are approved for integration into the device, ensuring batch-to-batch consistency in surface area, ionic accessibility, and mechanical response during pressure application.

Upon selection, the qualifying AC-coated electrodes undergo a delicate surface polishing procedure. A non-abrasive microfiber cloth is used to gently wipe the surface under a continuous flow of high-purity nitrogen gas. This step is intended to remove loosely adhered particles and surface dust without altering the microstructure of the carbon layer. The use of nitrogen gas during polishing prevents atmospheric moisture and particulate contamination, which can otherwise introduce inconsistencies in gel-electrolyte contact or act as defect sites during long-term electrochemical cycling. This gentle polishing ensures the AC film presents a clean, stable, and continuous contact surface for subsequent lamination with the PVA-KOH gel electrolyte, minimizing interface disruption and mechanical delamination during device assembly or operation.

In parallel, the deposition process for the SrO thin film on the positive electrode side is also enhanced through a staged deposition strategy. During the successive ionic layer adsorption and reaction (SILAR) cycles for SrO formation, the standard dipping and rinsing sequence is deliberately interrupted every 20 cycles with a controlled pause interval of 5 minutes. During each pause, the coated stainless-steel substrate is suspended vertically in a sealed, nitrogen-purged chamber to maintain a contaminant-free and moisture-controlled environment. This intermediate rest period allows the adsorbed precursor species to undergo stabilization, densification, and improved integration into the growing film matrix without immediate ionic interference from fresh reactants.

The staged approach serves two key purposes: first, it facilitates the gradual consolidation of the ionic network at the film surface, which reduces internal stresses and increases film density; second, it mitigates crack propagation by allowing the partial relaxation of structural strain induced by cumulative film growth. By preventing abrupt transitions in surface energy and chemical potential, the film exhibits enhanced mechanical integrity and superior interlayer adhesion when paired with the subsequent CdO layer. The result is a smooth, defect-minimized SrO film with improved crystallinity and long-range ordering, which is critical for the formation of a high-quality SrO//CdO heterojunction.

In an embodiment, during the preparation of the SrO and CdO precursor solutions, each nitrate salt—Sr(NO₃)₂ and Cd(NO₃)₂·3H₂O—is weighed using an analytical microbalance with a resolution of 0.1 mg and dissolved under continuous magnetic stirring at 350 rpm for 30 minutes in pre-warmed distilled water maintained at 308 K, and wherein each solution is aged for 12 hours in sealed amber bottles to stabilize ion-dissociation kinetics before use in SILAR cycles, thereby reducing inconsistencies in precursor activity and ensuring controlled ion-exchange reactions during thin film formation, and wherein the stainless-steel substrates used for both the positive and negative electrodes are subjected to mechanical polishing using progressively finer grades of alumina slurry down to 0.05 μm followed by ultrasonic cleaning in ethanol, acetone, and deionized water sequentially for 15 minutes each, and wherein the substrate surfaces are subsequently dried under high-purity nitrogen gas and stored in vacuum desiccators until use to prevent oxide reformation.

In an embodiment, the preparation of high-purity precursor solutions and the meticulous conditioning of the stainless-steel substrates are integral to achieving uniform, defect-free SrO and CdO thin films through the SILAR deposition process, thereby ensuring the electrochemical performance and long-term stability of the assembled asymmetric solid-state supercapacitor (ASSD). The synthesis of the precursor solutions begins with the precise weighing of each nitrate salt—strontium nitrate (Sr(NO₃)₂) and cadmium nitrate tetrahydrate (Cd(NO₃)₂·3H₂O)—using an analytical microbalance with a resolution of 0.1 mg. This high-accuracy measurement is essential to maintain stoichiometric control and batch-to-batch reproducibility in precursor concentration, which directly influences the film thickness and elemental composition during deposition.

Each weighed nitrate salt is dissolved in pre-warmed double-distilled water maintained at a temperature of 308 K (approximately 35° C.). This temperature facilitates rapid dissolution and consistent ion dissociation without thermal degradation of the hydrated salts. The dissolution is carried out under continuous magnetic stirring at 350 rpm for a duration of 30 minutes to ensure complete homogenization and to eliminate any undissolved solute aggregates. The resulting solutions are then transferred to sealed amber glass bottles and aged for 12 hours prior to use. This aging period stabilizes the ionic dissociation kinetics and mitigates fluctuations in ion activity, which are often responsible for film roughness, incomplete precipitation, or inconsistent adsorption behavior during SILAR cycles. The use of amber bottles also prevents photolytic decomposition of sensitive nitrate species, preserving the chemical integrity of the solution.

In parallel, the stainless-steel substrates used for both the SrO/CdO positive electrode and the activated carbon-based negative electrode undergo an intensive mechanical and chemical preparation protocol. Initially, mechanical polishing is conducted using alumina slurries of progressively decreasing particle size, culminating with a 0.05 μm slurry to ensure a mirror-finish surface with minimal roughness. This step is critical to remove machining marks, oxide films, and any micro-scale irregularities that could compromise thin-film adhesion or create nucleation centers for unwanted phases.

Following polishing, the substrates are sequentially cleaned in ultrasonic baths containing ethanol, acetone, and deionized water—each for 15 minutes. Ethanol and acetone remove organic residues and trace oils, while deionized water removes any residual inorganic particles or solvent residues. Ultrasonication ensures deep cleaning of surface grooves and prevents re-adsorption of contaminants during handling. After cleaning, the substrates are dried using a stream of high-purity nitrogen gas to prevent airborne moisture condensation or dust deposition.

To further preserve the pristine condition of the prepared substrates, they are stored in vacuum desiccators until they are ready for film deposition. The desiccator environment ensures that no re-oxidation of the metal surface occurs, maintaining a chemically reactive and hydrophilic surface ideal for the initial adsorption of Sr²⁺ and Cd²⁺ ions in the first SILAR cycles. Substrate surface quality is critical not only for film uniformity but also for minimizing interfacial resistance and enhancing the mechanical adhesion of the deposited layers.

Together, this embodiment ensures that all precursor and substrate preparation steps are executed under high-precision, contamination-free conditions. This level of process fidelity directly contributes to the formation of smooth, stoichiometrically controlled SrO and CdO films with excellent crystallinity and minimal defects. As a result, the electrochemical behavior of the final ASSD is significantly improved, with observed benefits including enhanced charge-discharge symmetry, higher capacitance retention, and reduced internal resistance—each of which is essential for high-performance, reliable energy storage in practical applications.

In an embodiment, the annealing process of the SrO//CdO composite thin film includes an intermediate dwell stage at 473 K for 30 minutes prior to ramping to the final temperature of 623 K, and wherein the thermal ramp rate is dynamically reduced to 2 K/min during this intermediate hold to promote organic residue burnout and solvent desorption from the substrate interface, and wherein this two-step annealing sequence is programmed in a PID-controlled furnace with real-time feedback correction, thereby minimizing thermal stress-induced delamination and ensuring uniform grain coalescence within the oxide structure, and wherein the AC slurry applied via doctor blade to the stainless-steel substrate is adjusted to a final viscosity of 700-800 cP using a Brookfield viscometer prior to application, and wherein the coating is carried out in a single pass using a gap height of 100 microns, followed by a leveling step on a vibration-isolated table for 30 minutes before drying, and wherein these control measures ensure film flatness deviation of less than ±5 microns.

In an embodiment, the thermal processing of the SrO//CdO composite thin film is refined through a meticulously designed two-step annealing protocol that enhances film crystallinity, removes volatile residues, and prevents structural degradation during temperature elevation. The annealing sequence is executed in a precision-controlled furnace equipped with a Proportional-Integral-Derivative (PID) feedback system to dynamically regulate temperature ramps and hold stages. Initially, the annealing process introduces an intermediate dwell at 473 K for a duration of 30 minutes. This stage is crucial for the thermal degradation and desorption of organic residues and any entrapped solvent species remaining from the SILAR deposition process or surface treatments. By incorporating this pre-activation thermal plateau, the system minimizes the risk of rapid outgassing during higher temperature exposure, which could otherwise create voids, delamination, or microcracks in the growing oxide lattice.

During this intermediate hold, the ramp rate is intentionally reduced to 2 K/min, providing a gradual transition into the thermal equilibrium zone. This slow ramp ensures minimal mechanical stress accumulation within the bilayer structure and allows time for the release of internal stresses resulting from lattice mismatch or adsorbate migration. After completing the dwell period, the temperature is further ramped up to the final annealing target of 623 K at a moderated rate, ensuring smooth grain boundary evolution and uniform phase transformation across both the SrO and CdO layers. The PID controller continuously adjusts the heating profile in real-time based on internal thermocouple feedback, ensuring thermal uniformity across the furnace chamber. This methodical annealing sequence yields a highly ordered oxide matrix with improved grain connectivity and interfacial coherence, which directly benefits the charge transport properties and structural resilience of the thin film.

In parallel, the preparation of the negative electrode, consisting of activated carbon (AC) applied onto a stainless-steel substrate via the doctor blade method, involves strict control of rheological and mechanical parameters to ensure high surface quality and consistent performance. Prior to coating, the AC slurry is formulated and adjusted to a target viscosity in the range of 700-800 centipoise (cP), as verified using a Brookfield viscometer. This viscosity range is optimized to facilitate smooth spreading, adequate particle suspension, and adhesion without sagging or sedimentation. The coating is applied in a single pass using a doctor blade with a precisely set gap height of 100 microns, providing a consistent film thickness suitable for maintaining both mechanical integrity and effective ionic diffusion.

Immediately after deposition, the coated substrate is placed on a vibration-isolated leveling table for 30 minutes. This step allows the slurry to self-level and redistribute evenly across the substrate surface before the drying phase, thereby mitigating the formation of ridges, pinholes, or gradient thickness zones. These precautions ensure that the final dried film maintains a flatness deviation of less than ±5 microns, as confirmed by surface profilometry. Such flatness is critical for uniform contact with the gel electrolyte layer and for preserving mechanical symmetry during multi-layer pressing, directly impacting the reliability and efficiency of the final device. The dual-stage annealing of the SrO//CdO composite film and the controlled rheology and deposition of the AC layer work synergistically to minimize structural defects, enhance electrochemical uniformity, and ensure repeatable fabrication outcomes. The resulting supercapacitor devices exhibit improved electrochemical capacitance, reduced interfacial resistance, and exceptional mechanical stability across multiple charge-discharge cycles, thus validating the technical efficacy and scalability of the described process.

In an embodiment, during the deposition of SrO via SILAR, after every 10 immersion cycles, the substrate is gently withdrawn at a constant angular inclination of 30 degrees relative to the vertical axis, wherein the withdrawal rate is maintained at 2 mm/sec to allow gravitational shearing of excess precursor, and wherein this specific angular motion facilitates alignment of loosely adsorbed ionic species along the surface energy gradient, thereby enhancing anisotropic grain growth and resulting in a textured film architecture optimized for charge mobility in the final device, wherein the Sr(NO₃)₂ and Cd(NO₃)₂·3H₂O precursor solutions are allowed to undergo controlled aging for 48 hours in sealed glass vessels maintained at 298 K in darkness prior to use, and wherein the solutions are gently agitated every 12 hours during aging to ensure homogeneity of ionic dispersion, and wherein the UV-Vis absorbance spectra of aged solutions are verified for consistency within ±2% of initial peak absorbance at 310 nm and 380 nm respectively for Sr and Cd.

In an embodiment, the deposition of the SrO thin film via the Successive Ionic Layer Adsorption and Reaction (SILAR) method incorporates an innovative angular withdrawal technique designed to enhance film morphology and promote anisotropic grain orientation. After every 10 immersion cycles during SrO deposition, the stainless-steel substrate is gently withdrawn from the precursor solution at a fixed angular inclination of 30 degrees relative to the vertical axis. The withdrawal rate is precisely maintained at 2 mm/sec to allow gravitational shearing forces to act on the loosely adhered precursor layer. This gravitational gradient, in conjunction with the inclined withdrawal, causes partial realignment of loosely adsorbed Sr²⁺ and OH⁻ species along the dominant surface energy axes of the substrate, which favors anisotropic grain growth during subsequent drying and reaction stages. The result is a textured SrO film with preferential orientation and enhanced crystallographic alignment, which supports improved charge mobility and lower interfacial resistance when integrated into the final asymmetric solid-state supercapacitor device.

This modulated physical motion is supplemented by an equally rigorous chemical preparation of the precursor solutions. Both Sr(NO₃)₂ and Cd(NO₃)₂·3H₂O solutions are subjected to a 48-hour controlled aging process prior to use in the SILAR cycles. Each solution is stored in sealed, chemically inert glass vessels maintained at a stable temperature of 298 K and protected from light to avoid photodegradation or photoreduction of metal ions. During the aging period, the solutions are gently agitated every 12 hours to maintain homogeneity of ionic dispersion and prevent salt precipitation or stratification. This controlled aging allows the ions to reach a quasi-equilibrium dissociation state, thereby stabilizing their reactivity and reducing variability in deposition kinetics across multiple cycles.

To verify the consistency of the aged solutions, UV-Vis absorbance spectroscopy is performed, with spectra acquired from each precursor solution at predetermined intervals. The absorbance peaks are monitored at 310 nm for strontium and 380 nm for cadmium-wavelengths corresponding to their respective nitrate complexes. Only those solutions exhibiting absorbance variability within ±2% of the initial standard values are approved for use, ensuring that the ionic strength and precursor activity remain within strict tolerances. This step ensures that each cycle of the SILAR deposition process contributes uniformly to film growth, preventing unintended variations in thickness, stoichiometry, or crystallographic phase composition.

In an embodiment, prior to stacking, the SrO//CdO composite thin film is subjected to a dry nitrogen jet at 10 psi for 90 seconds at a distance of 10 cm to remove adsorbed particulates and minimize atmospheric hydration, and wherein the surface is subsequently scanned using contact-mode atomic force microscopy to confirm surface roughness uniformity within ±10 nm over 50 um² scan areas, and wherein only films meeting this criterion are accepted for assembly, thereby reducing localized interfacial porosity and increasing electrolyte adhesion uniformity during compression, wherein during the final pressing of the multi-layer stack, a dynamic pulse-pressure sequence is applied consisting of three successive pressure cycles of 2 MPa for 3 minutes each, followed by one final 6 MPa press for 5 minutes, and wherein the platen temperature is controlled at 308 K during the entire sequence, and wherein this cyclic pre-compression approach allows controlled viscoelastic settling of the gel electrolyte layer between electrodes, thereby improving long-term mechanical cohesion and interfacial capacitance retention under electrochemical cycling, wherein the SrO and CdO films formed on the stainless steel substrate exhibit a bilayer interface, and wherein a slow gradient in crystallographic phase transition is induced by performing the final 10 CdO SILAR cycles at a reduced immersion time of 30 seconds instead of 60 seconds, thereby gradually reducing cadmium ion density near the interface, and wherein this microgradient structure is confirmed via cross-sectional TEM imaging to show a diffusion-limited intermixing zone not exceeding 50 nm.

In an embodiment, prior to the final stacking and assembly of the asymmetric solid-state supercapacitor (ASSD), the SrO//CdO composite thin film undergoes a precision surface conditioning and verification protocol to ensure optimal cleanliness, interfacial compatibility, and mechanical uniformity. The composite thin film, deposited on a stainless-steel substrate, is first exposed to a directed dry nitrogen jet at 10 psi for 90 seconds from a fixed distance of 10 cm. This step is designed to remove ambient particulates that may have adsorbed onto the surface during handling or post-deposition processes, as well as to minimize atmospheric hydration that could compromise surface reactivity and uniform adhesion of the gel electrolyte layer. The use of dry nitrogen eliminates moisture-related surface interactions without introducing electrostatic discharge or mechanical abrasion, thereby preserving the structural integrity of the thin film.

Following this cleaning procedure, the surface is characterized using contact-mode atomic force microscopy (AFM) to assess nanoscale roughness. AFM scans are conducted over a 50 um² area, and only those films exhibiting a surface roughness uniformity within ±10 nm are approved for assembly. This rigorous selection ensures that the electrode-electrolyte interface will be free from localized porosity or air gaps, which are known to introduce ionic discontinuities and increase internal resistance during device operation. Such uniformity also promotes homogeneous compression and adhesion during lamination, directly impacting mechanical stability and electrochemical efficiency.

During the final stack pressing process, a dynamic pulse-pressure sequence is applied to further enhance the cohesion between the SrO//CdO positive electrode, PVA-KOH gel electrolyte, and the activated carbon negative electrode. The sequence begins with three successive pressure cycles of 2 MPa, each held for 3 minutes, followed by a final compression at 6 MPa for 5 minutes. This staged approach allows for controlled viscoelastic settling of the gel electrolyte layer, gradually conforming it to the microstructure of both electrode surfaces. The platen temperature is maintained at 308 K throughout the process to soften the gel slightly, improving its ability to flow into surface asperities while preventing dehydration or thermal degradation of the polymeric matrix. This method ensures strong mechanical adhesion across all interfaces, reduces interfacial voids, and preserves the flatness of the stacked assembly, which are critical factors for long-term cycling durability and capacitance retention.

Furthermore, this embodiment introduces a novel phase-gradient engineering technique during the final stages of CdO deposition. Specifically, the last 10 SILAR cycles for CdO are performed at a reduced immersion time of 30 seconds per step, compared to the standard 60 seconds. This reduction in immersion time strategically limits the availability of cadmium ions at the SrO/CdO interface, gradually transitioning the cadmium ion density and thereby creating a diffusion-controlled gradient in crystallographic phase composition. This microgradient enhances the structural coherence of the bilayer junction by minimizing abrupt lattice mismatches and suppressing defect formation at the oxide interface.

The presence and morphology of this gradient are verified using high-resolution cross-sectional transmission electron microscopy (TEM), which reveals a diffusion-limited intermixing zone not exceeding 50 nm in thickness. This interfacial gradient supports superior heterojunction integrity by promoting smoother electronic and ionic transport pathways, effectively reducing charge trapping and enhancing the electrochemical response of the device.

In an embodiment, after gelation of the PVA-KOH electrolyte, the material is stored in a humidity-controlled chamber with RH maintained at 20-25% for 24 hours prior to integration, and wherein the water content in the gel is evaluated gravimetrically to confirm a final weight loss of no more than 8% relative to the hydrated mass, and wherein this pre-conditioning step ensures optimal water activity for ion migration without promoting excessive swelling, thereby enhancing the ionic conductivity and mechanical integrity of the separator layer during device operation, wherein the interface between the gel electrolyte and the activated carbon electrode is modified by incorporating a transitional semi-porous binder layer formed by spin-coating a 0.5 wt % PVA-KOH solution onto the AC surface at 1000 rpm for 45 seconds prior to final stacking, and wherein this transitional layer exhibits an average pore size of 100-200 nm as measured by BET analysis, and wherein the pore size gradient allows ion buffering during rapid charge-discharge cycles.

In an embodiment, the performance and longevity of the asymmetric solid-state supercapacitor (ASSD) are further enhanced through the pre-conditioning and strategic interface engineering of the PVA-KOH gel electrolyte. Following the initial gelation process, the PVA-KOH hydrogel is not integrated immediately but is instead subjected to a carefully controlled aging protocol. The gel is stored in a humidity-controlled chamber with the relative humidity (RH) maintained within the range of 20-25% for a continuous duration of 24 hours. This environment is specifically chosen to promote gradual equilibration of the water content within the gel, ensuring that the electrolyte attains an optimal hydration state—sufficient to facilitate efficient ionic mobility but low enough to avoid excessive swelling or mechanical softening during electrochemical cycling.

The water activity in the gel is quantified via a gravimetric analysis in which the weight loss of the gel is measured relative to its initial hydrated mass. Only gels that exhibit a total weight loss of no more than 8% are deemed suitable for device integration. This threshold ensures that the gel retains a consistent level of hydration necessary for maintaining high ionic conductivity, while also achieving mechanical stability and dimensional integrity, especially under compression and temperature fluctuations. By optimizing the gel's internal water content, this pre-conditioning step plays a crucial role in suppressing delamination and internal resistance during operation.

To further enhance the interfacial contact between the gel electrolyte and the activated carbon (AC) negative electrode, a transitional semi-porous binder layer is introduced as a functional intermediary. This layer is created by spin-coating a 0.5 wt % PVA-KOH solution directly onto the surface of the AC-coated stainless-steel electrode. The spin-coating is performed at 1000 rpm for 45 seconds, resulting in a uniform film that seamlessly conforms to the rough topography of the carbon layer. Upon drying under ambient conditions, the coated layer forms a semi-porous network that acts both as an ionic bridge and as a physical buffer.

The morphology of this transitional layer is characterized using Brunauer-Emmett-Teller (BET) surface area analysis, which reveals an average pore size distribution in the range of 100-200 nm. These nanoscopic pores are strategically sized to function as ionic reservoirs during fast charge-discharge cycles, facilitating rapid ionic transport across the gel-carbon interface. The pore size gradient created by the semi-porous binder smoothens the ion diffusion pathway and accommodates transient ionic concentrations, thus preventing local charge saturation and reducing capacitance fade over extended cycling.

This embodiment effectively combines electrolyte stabilization with interfacial engineering to maximize the performance of the ASSD. By regulating water content and introducing a nanostructured intermediate layer, it mitigates key failure mechanisms such as gel dehydration, poor interface adhesion, and ionic bottlenecks. Devices fabricated using this method demonstrate superior electrochemical characteristics, including high specific capacitance, low equivalent series resistance, and excellent rate capability, particularly under high-frequency operating conditions. The layered design also contributes to prolonged mechanical and electrochemical durability, reinforcing the practicality of this approach for commercial solid-state energy storage applications.

In a further embodiment, the SrO//CdO composite thin film, comprising preparing a first solution comprising 0.5 M Sr(NO₃)₂ in a first beaker, a second solution comprising distilled water in a second beaker, a third solution comprising 1 M NaOH in a third beaker, a fourth solution comprising distilled water in a fourth beaker, a fifth solution comprising 0.5 M Cd(NO₃)₂·3H₂O in a fifth beaker, a sixth solution comprising distilled water in a sixth beaker, and a seventh solution comprising 1 M NaOH in a seventh beaker. Then, dipping a substrate into the first solution for 60 seconds and rinsing the substrate in the second solution for 20 seconds, wherein the dipping and rinsing of the substrate is repeated for 80 cycles for adsorption and reaction of the Sr(NO₃)₂ precursor. Then, dipping the substrate into the third solution to induce SrO precipitation and rinsing the substrate in the fourth solution. Then, dipping the substrate into the fifth solution for 60 seconds and rinsing the substrate in the sixth solution for 20 seconds for 80 cycles to ensure adsorption and reaction of the Cd(NO₃)₂ precursor. Then, dipping the substrate into the seventh solution to induce CdO precipitation and rinsing the substrate in the fourth solution. Thereafter, annealing the coated substrate at 623 K for 1 hour to enhance crystallinity and stability, thereby forming the SrO//CdO composite thin film.

In one of the above embodiments, the SrO thin film is synthesized by forming SrO from the reaction between Sr²⁺ ions from SrO(NO₃)₂ and hydroxide ions from NaOH solution.

Yet, in a further embodiment, the CdO thin film is synthesized by forming CdO from the reaction between cadmium hydroxide precipitated from Cd(NO₃)₂·3H₂O and NaOH solution.

Yet, in another embodiment, the activated carbon (AC) negative electrode fabrication comprising preparing a polyvinyl alcohol (PVA) solution by dissolving 1 gram of polyvinyl alcohol (PVA) in 10-15 milliliters of distilled water. Then, heating and stirring the PVA solution until the PVA is completely dissolved. Then, adding activated carbon (AC) to the dissolved PVA solution and stirring the mixture. Then, drying the resulting PVA-AC slurry in a desiccator. Then, applying the dried PVA-AC slurry to a stainless steel (SS) substrate using a doctor blade to form a coated substrate. Then, air-drying the coated substrate at room temperature for approximately 4 hours, thereafter, heat-treating the air-dried coated substrate in a muffle furnace at approximately 353 K for approximately 6-7 hours.

In another embodiment, the PVA solution is heated and stirred at a temperature between approximately 343 K and approximately 353 K for approximately 2-3 hours.

In another embodiment, the AC is added to the dissolved PVA solution, and the mixture is stirred for approximately 2 hours at a temperature between approximately 343 K and approximately 353 K.

In another embodiment, the PVA-KOH gel electrolyte preparation, comprising the steps of dissolving 3-4 grams of polyvinyl alcohol (PVA) in 40-50 milliliters of double-distilled water (DDW) to obtain a mixture. Then, heating the mixture to a temperature of 348-353 K while continuously stirring to form a viscous, clear gel. Then, cooling the gel to room temperature. Then, gradually adding 10-15 milliliters of a 1 M KOH solution to the cooled gel and stirring the mixture for 6-7 hours. Then, transferring the resulting solution to a Petri dish. Thereafter, allowing the solution to dry at room temperature to form a flexible, uniform alkaline electrolyte separator layer.

The developed method synthesizes a SrO//CdO thin film electrode for supercapacitors via the SILAR technique, involving sequential layer-by-layer deposition of SrO and CdO films onto a conductive stainless still (SS) substrate, forming a SrO//CdO composite structure with enhanced energy storage. The SrO and CdO films are deposited in alternating layers, resulting in a synergetic composite phase enhancing the electrode electrochemical stability and specific capacitance. The composite thin film is annealed post-deposition to improve crystallinity and adhesion to the substrate. The deposition cycle for each layer comprises a 60-second dip in a solution containing the respective metal ions, followed by a rinsing step, and an immersion in a basic solution to induce oxide formation.

The SrO layer is formed using Sr(NO₃)₂ in water and NaOH solutions, and the CdO layer is formed using Cd(NO₃)₂ and NaOH solutions. The SrO//CdO thin film is configured to achieve a crystallite size optimized for enhanced electrochemical properties, with sizes ranging between 25-48 nm. The thin film demonstrates improved energy density due to reduced crystallite size achieved by the composite deposition. The SrO and CdO layers are deposited in a stoichiometric ratio that maximizes the dielectric and electrochemical properties for high-capacity energy storage. The substrate is annealed at a temperature between 500-650 K to enhance the crystal structure and improve the film overall stability.

The SrO//CdO thin film electrode achieves a Cs above 700 F/g at a sweep rate of 5 mV/s in a 1M KOH electrolyte.

A supercapacitor device comprising the electrode produced by the method, where the SrO//CdO thin film electrode is configured to provide rapid charge-discharge capabilities with minimal capacitance decay over 6000 cycles. The specific energy density of the supercapacitor exceeds 80 Wh/kg at a power density of 3 kW/kg, making it suitable for high-performance energy storage applications.

The device includes a PVA≤KOH gel as a solid-state electrolyte, optimizing ionic conductivity and preventing electrolyte leakage. The device has a balanced structure with an activated carbon electrode as the negative electrode, providing enhanced cyclic stability. The asymmetric design facilitates an extended voltage window of operation, increasing the overall energy storage capability of the device.

The SrO//CdO electrode is configured with a porosity optimized for ion diffusion, enhancing rate capability and reducing internal resistance. The Nyquist plot demonstrates an internal resistance (Ri) of less than 1 Ω, signifying high electrical conductivity. The device exhibits a charge transfer resistance (RCT) below 2.5 Ω, contributing to efficient electron transport during operation. The SrO//CdO thin film maintains a capacitance retention of at least 85% over 6000 charge-discharge cycles.

The synthesis parameters of ion concentration, immersion time, and deposition cycle number are tailored to achieve an optimized balance between high energy density and structural stability for long-term supercapacitor performance.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for fabricating an asymmetric solid-state device (ASSD), comprising:
synthesizing an SrO//CdO composite thin film on a conductive substrate to form a positive electrode;
providing an activated carbon (AC) negative electrode;
preparing a gel electrolyte consisting of 1M Polyvinyl Alcohol-Potassium Hydroxide (PVA-KOH) composition for use between the positive and negative electrodes;
stacking the SrO/CdO positive electrode, the 1M PVA-KOH gel electrolyte, and the AC negative electrode in a multi-layer arrangement; and
pressing the stacked layers together to form the asymmetric solid-state device (ASSD), the asymmetric solid-state device (ASSD) comprising:
the positive electrode comprising a SrO thin film and a CdO thin film on a conductive substrate, the negative electrode comprising activated carbon (AC); and the 1M PVA-KOH gel electrolyte positioned between the positive and negative electrodes,
wherein the device is formed by stacking the components in layers and pressing them together;
wherein the SrO and CdO thin films are synthesized using a solution-immersion layer-by-layer (SILAR) method, for uniform deposition and strong bonding to a conductive substrate, wherein the conductive substrate is stainless steel, and wherein the SrO//CdO composite thin film, comprising:
preparing a first solution comprising 0.5 M Sr(NO₃)₂ in a first beaker, a second solution comprising distilled water in a second beaker, a third solution comprising 1 M NaOH in a third beaker, a fourth solution comprising distilled water in a fourth beaker, a fifth solution comprising 0.5 M Cd(NO₃)₂·3H₂O in a fifth beaker, a sixth solution comprising distilled water in a sixth beaker, and a seventh solution comprising 1 M NaOH in a seventh beaker;
dipping a substrate into the first solution for 60 seconds and rinsing the substrate in the second solution for 20 seconds, wherein the dipping and rinsing of the substrate is repeated for 80 cycles for adsorption and reaction of the Sr(NO₃)₂ precursor;
dipping the substrate into the third solution to induce SrO precipitation and rinsing the substrate in the fourth solution;
dipping the substrate into the fifth solution for 60 seconds and rinsing the substrate in the sixth solution for 20 seconds for 80 cycles to ensure adsorption and reaction of the Cd(NO₃)₂ precursor;
dipping the substrate into the seventh solution to induce CdO precipitation and rinsing the substrate in the fourth solution; and
annealing the coated substrate at 623 K for 1 hour to enhance crystallinity and stability, thereby forming the SrO//CdO composite thin film.

2. The method of claim 1, wherein the SrO thin film is synthesized by forming SrO from the reaction between Sr²⁺ ions from SrO(NO₃)₂ and hydroxide ions from NaOH solution, and wherein the CdO thin film is synthesized by forming CdO from the reaction between cadmium hydroxide precipitated from Cd(NO₃)₂·3H₂O and NaOH solution.

3. The method of claim 1, wherein the activated carbon (AC) negative electrode fabrication comprising:
preparing a polyvinyl alcohol (PVA) solution by dissolving 1 gram of polyvinyl alcohol (PVA) in 10-15 milliliters of distilled water;
heating and stirring the PVA solution until the PVA is completely dissolved;
adding activated carbon (AC) to the dissolved PVA solution and stirring the mixture;
drying the resulting PVA-AC slurry in a desiccator;
applying the dried PVA-AC slurry to a stainless steel (SS) substrate using a doctor blade to form a coated substrate;
air-drying the coated substrate at room temperature for approximately 4 hours; and
heat-treating the air-dried coated substrate in a muffle furnace at approximately 353 K for approximately 6-7 hours,
wherein the PVA solution is heated and stirred at a temperature between approximately 343 K and approximately 353 K for approximately 2-3 hours, and wherein the AC is added to the dissolved PVA solution, and the mixture is stirred for approximately 2 hours at a temperature between approximately 343 K and approximately 353 K.

4. The method of claim 1, wherein the PVA-KOH gel electrolyte preparation, comprising the steps of:
dissolving 3-4 grams of polyvinyl alcohol (PVA) in 40-50 milliliters of double-distilled water (DDW) to obtain a mixture;
heating the mixture to a temperature of 348-353 K while continuously stirring to form a viscous, clear gel;
cooling the gel to room temperature;
gradually adding 10-15 milliliters of a 1 M KOH solution to the cooled gel and stirring the mixture for 6-7 hours;
transferring the resulting solution to a Petri dish; and
allowing the solution to dry at room temperature to form a flexible, uniform alkaline electrolyte separator layer.

5. The method of claim 1, wherein the step of synthesizing the SrO thin film using the SILAR method further comprises maintaining the pH of the NaOH solution used for SrO precipitation between approximately 12.5 and 13.2 to promote uniform nucleation and controlled grain growth of Sr(OH)₂ on the stainless-steel substrate, and wherein the temperature of the solution bath during the immersion cycles is maintained at 298-303 K to ensure controlled ionic interaction, and wherein the substrate is oriented vertically and agitated gently during each dipping step to avoid sedimentation and to ensure homogeneous film thickness, and wherein the rinsing duration after each Sr(NO₃)₂ immersion is precisely timed to avoid premature dissolution of loosely bound Sr²⁺ ions, and wherein the dipping cycles for CdO thin film deposition are carried out immediately after SrO deposition without any thermal treatment between the two processes, and wherein each Cd(NO₃)₂ dipping step is preceded by a 5-second exposure of the substrate to ultrasonic agitation to dislodge residual Sr(OH)₂ clusters, and wherein the NaOH solution for CdO precipitation is maintained at a temperature of 308-313 K to increase hydroxide ion mobility, and wherein each Cd(NO₃)₂ immersion is performed under low-light conditions to minimize unintended photolytic decomposition of the precursor, and wherein the rinsing steps use double-distilled water at a conductivity not exceeding 1 μS/cm to prevent ionic contamination.

6. The method of claim 1, wherein the annealing step of the SrO//CdO composite thin film is conducted in a programmable furnace under ambient atmospheric conditions with a controlled ramp-up rate of 5 K/min until the target temperature of 623 K is reached, wherein the film is held at 623 K for exactly 60 minutes followed by a controlled cooling rate of 2 K/min to room temperature to avoid thermal cracking, and wherein the annealing chamber is pre-heated and purged of moisture for 15 minutes prior to insertion of the coated substrate, and wherein the film is positioned at the geometric center of the furnace to maintain uniform heat distribution, and wherein the activated carbon (AC) used for the negative electrode is pre-treated by ultrasonication in ethanol for 30 minutes to remove organic impurities, followed by vacuum drying at 373 K for 4 hours before being added to the PVA solution, and wherein the PVA-AC slurry is continuously stirred using a magnetic stirrer operating at 400-500 rpm during the dissolution and mixing process to ensure uniform dispersion of AC particles, and wherein the dried PVA-AC film on the stainless-steel substrate is subjected to a surface profilometry test to confirm a coating thickness of 70-80 microns before being subjected to the heat-treatment step, and wherein the coated substrate is placed in the muffle furnace with its active surface facing upward on a ceramic tray to prevent distortion.

7. The method of claim 4, wherein during the gel electrolyte preparation, the polyvinyl alcohol (PVA) is added gradually to pre-heated double-distilled water maintained at 348-353 K over a period of 15 minutes to avoid clumping, and wherein the stirring process is performed with a Teflon-coated overhead stirrer at 250-300 rpm to maintain homogeneity of the polymer solution, and wherein after cooling to ambient temperature, the 1 M KOH solution is introduced dropwise over 20 minutes under constant stirring to prevent localized pH spikes, and wherein the resulting gel is allowed to rest undisturbed for 2 hours to eliminate entrapped air bubbles before being cast into a Petri dish, and wherein the Petri dish is covered with a breathable film to control evaporation rate, resulting in a flexible, crack-free, and ionically conductive electrolyte layer with high mechanical integrity.

8. The method of claim 1, wherein the stacking of the SrO/CdO positive electrode, PVA-KOH gel electrolyte, and AC negative electrode is carried out in a controlled environment chamber with relative humidity maintained below 30% to prevent premature hydration or delamination of the gel layer, and wherein each layer is aligned using an optical micrometer system to ensure misalignment does not exceed ±10 microns, and wherein the pressure applied during the pressing step is calibrated at 5 MPa for a dwell time of 10 minutes using a hydraulic press with parallel platens, and wherein the pressing is conducted at a temperature of 313 K to soften the gel interface slightly, and
wherein prior to initiating the SILAR deposition process, the stainless-steel conductive substrate is subjected to a dual-stage surface activation comprising: (i) chemical etching in a 1:1 volume ratio mixture of concentrated HCl and ethanol for 5 minutes to remove native oxide layers; and (ii) subsequent ultrasonication in acetone for 20 minutes followed by rinsing in distilled water and drying at 353 K, wherein the surface roughness is measured using atomic force microscopy (AFM) to confirm a Ra value of less than 50 nm before film deposition.

9. The method of claim 1, wherein after deposition of the SrO layer but before initiation of CdO layer deposition, the SrO-coated substrate is exposed to a mild oxygen plasma treatment for 3 minutes at a power of 100 W and a pressure of 0.2 Torr, wherein the plasma-treated surface undergoes temporary activation to increase the number of reactive surface hydroxyl groups, and wherein this surface activation step leads to enhanced anchoring of cadmium ions during the subsequent SILAR cycles, thereby reducing interfacial voids and improving heterojunction integrity between the SrO and CdO layers, and wherein the final SrO//CdO thin film prior to annealing is subjected to an in-situ UV-Vis absorbance scan in the range of 200-800 nm to confirm precursor film uniformity and light absorption consistency, and wherein only films that exhibit an absorbance variance of less than ±5% across scanned locations are subjected to thermal annealing.

10. The method of claim 1, wherein the NaOH solutions used for both SrO and CdO precipitation steps are pre-degassed using nitrogen bubbling for 15 minutes to eliminate dissolved oxygen, and wherein the solutions are filtered using 0.22 μm membrane filters immediately before use to eliminate particulate contaminants, and wherein the beakers containing these solutions are kept sealed with parafilm between dipping cycles, thereby ensuring minimal introduction of ambient CO₂ which could otherwise alter pH and introduce carbonate-related impurities into the oxide films, and wherein after formation of the SrO//CdO composite thin film but prior to device assembly, the film is aged under vacuum at a pressure of <0.01 Torr for 12 hours at room temperature to desorb any residual moisture and volatile contaminants from the surface, and wherein this vacuum-aging step is conducted in a glass desiccator with integrated humidity sensors to ensure internal RH does not exceed 5%.

11. The method of claim 1, wherein during the multi-layer stacking step, a thin interfacial buffer layer of 1-2 micrometers comprising a neutralized PVA-KOH dispersion is applied between each electrode and the gel electrolyte using spin-coating at 2000 rpm for 30 seconds, wherein the buffer layer serves to fill surface microvoids and enhance ionic contact, and wherein the thickness of each interface is verified via optical profilometry to maintain symmetric mechanical compression during pressing, thereby reducing internal resistance and improving ionic conductivity through the assembled ASSD, and wherein the assembled asymmetric solid-state device is subjected to a low-voltage electrochemical pre-conditioning step by applying a 0.5 V DC bias across the electrodes for 1 hour in a controlled chamber at 298 K and 20% RH.

12. The method of claim 1, wherein after heat treatment of the activated carbon (AC) coated electrode, the surface is scanned using scanning electron microscopy (SEM) at 5 kV accelerating voltage to assess the particle distribution homogeneity, and wherein only electrodes exhibiting a pore distribution variance within ±10% are selected for device assembly, and wherein the selected electrode is then lightly polished with non-abrasive microfiber under nitrogen gas flow to remove loosely adhered particles, thereby ensuring consistent surface contact with the gel electrolyte and minimizing interface disruption under pressure, and wherein during the SrO deposition cycles, the dipping and rinsing sequence is interrupted every 20 cycles by a pause interval of 5 minutes to allow intermediate precursor settling, wherein during each pause, the substrate is suspended vertically in a nitrogen-purged chamber to prevent contamination, and wherein this staged deposition approach promotes layer densification and minimizes crack propagation by enabling periodic stabilization of ionic species on the surface.

13. The method of claim 1, wherein during the preparation of the SrO and CdO precursor solutions, each nitrate salt—Sr(NO₃)₂ and Cd(NO₃)₂·3H₂O—is weighed using an analytical microbalance with a resolution of 0.1 mg and dissolved under continuous magnetic stirring at 350 rpm for 30 minutes in pre-warmed distilled water maintained at 308 K, and wherein each solution is aged for 12 hours in sealed amber bottles to stabilize ion-dissociation kinetics before use in SILAR cycles, thereby reducing inconsistencies in precursor activity and ensuring controlled ion-exchange reactions during thin film formation, and wherein the stainless-steel substrates used for both the positive and negative electrodes are subjected to mechanical polishing using progressively finer grades of alumina slurry down to 0.05 μm followed by ultrasonic cleaning in ethanol, acetone, and deionized water sequentially for 15 minutes each, and wherein the substrate surfaces are subsequently dried under high-purity nitrogen gas and stored in vacuum desiccators until use to prevent oxide reformation.

14. The method of claim 1, wherein the annealing process of the SrO//CdO composite thin film includes an intermediate dwell stage at 473 K for 30 minutes prior to ramping to the final temperature of 623 K, and wherein the thermal ramp rate is dynamically reduced to 2 K/min during this intermediate hold to promote organic residue burnout and solvent desorption from the substrate interface, and wherein this two-step annealing sequence is programmed in a PID-controlled furnace with real-time feedback correction, thereby minimizing thermal stress-induced delamination and ensuring uniform grain coalescence within the oxide structure, and wherein the AC slurry applied via doctor blade to the stainless-steel substrate is adjusted to a final viscosity of 700-800 cP using a Brookfield viscometer prior to application, and wherein the coating is carried out in a single pass using a gap height of 100 microns, followed by a leveling step on a vibration-isolated table for 30 minutes before drying, and wherein these control measures ensure film flatness deviation of less than ±5 microns.

15. The method of claim 1, wherein during the deposition of SrO via SILAR, after every 10 immersion cycles, the substrate is gently withdrawn at a constant angular inclination of 30 degrees relative to the vertical axis, wherein the withdrawal rate is maintained at 2 mm/sec to allow gravitational shearing of excess precursor, and wherein this specific angular motion facilitates alignment of loosely adsorbed ionic species along the surface energy gradient, thereby enhancing anisotropic grain growth and resulting in a textured film architecture optimized for charge mobility in the final device, wherein the Sr(NO₃)₂ and Cd(NO₃)₂·3H₂O precursor solutions are allowed to undergo controlled aging for 48 hours in sealed glass vessels maintained at 298 K in darkness prior to use, and wherein the solutions are gently agitated every 12 hours during aging to ensure homogeneity of ionic dispersion, and wherein the UV-Vis absorbance spectra of aged solutions are verified for consistency within ±2% of initial peak absorbance at 310 nm and 380 nm respectively for Sr and Cd.

16. The method of claim 1, wherein prior to stacking, the SrO//CdO composite thin film is subjected to a dry nitrogen jet at 10 psi for 90 seconds at a distance of 10 cm to remove adsorbed particulates and minimize atmospheric hydration, and wherein the surface is subsequently scanned using contact-mode atomic force microscopy to confirm surface roughness uniformity within ±10 nm over 50 μm² scan areas, and wherein only films meeting this criterion are accepted for assembly, thereby reducing localized interfacial porosity and increasing electrolyte adhesion uniformity during compression, wherein during the final pressing of the multi-layer stack, a dynamic pulse-pressure sequence is applied consisting of three successive pressure cycles of 2 MPa for 3 minutes each, followed by one final 6 MPa press for 5 minutes, and wherein the platen temperature is controlled at 308 K during the entire sequence, and wherein this cyclic pre-compression approach allows controlled viscoelastic settling of the gel electrolyte layer between electrodes, thereby improving long-term mechanical cohesion and interfacial capacitance retention under electrochemical cycling, wherein the SrO and CdO films formed on the stainless steel substrate exhibit a bilayer interface, and wherein a slow gradient in crystallographic phase transition is induced by performing the final 10 CdO SILAR cycles at a reduced immersion time of 30 seconds instead of 60 seconds, thereby gradually reducing cadmium ion density near the interface, and wherein this microgradient structure is confirmed via cross-sectional TEM imaging to show a diffusion-limited intermixing zone not exceeding 50 nm.

17. The method of claim 1, wherein after gelation of the PVA-KOH electrolyte, the material is stored in a humidity-controlled chamber with RH maintained at 20-25% for 24 hours prior to integration, and wherein the water content in the gel is evaluated gravimetrically to confirm a final weight loss of no more than 8% relative to the hydrated mass, and wherein this pre-conditioning step ensures optimal water activity for ion migration without promoting excessive swelling, thereby enhancing the ionic conductivity and mechanical integrity of the separator layer during device operation, wherein the interface between the gel electrolyte and the activated carbon electrode is modified by incorporating a transitional semi-porous binder layer formed by spin-coating a 0.5 wt % PVA-KOH solution onto the AC surface at 1000 rpm for 45 seconds prior to final stacking, and wherein this transitional layer exhibits an average pore size of 100-200 nm as measured by BET analysis, and wherein the pore size gradient allows ion buffering during rapid charge-discharge cycles.
